(19) United States
(12) Patent Application Publication
(10) Pub. No.: US 2013/0317159 A1
(43) Pub. Date: Nov. 28, 2013

(54) Reinforced Poly(Arylene Sulfide) Compositions

(71) Applicants: Jon F. Geibel, Bartlesvilles, OK (US); David F. Register, Bartlesville, OK (US); Ta Yen Ching, Danville, CA (US); R. Shawn Childress, Bartlesville, OK (US); Jeffrey S. Fodor, Bartlesville, OK (US); Kent E. Mitchell, Bartlesville, OK (US); Howard S. Ferrell, Caney, KS (US)

(72) Inventors: Jon F. Geibel, Bartlesvilles, OK (US); David F. Register, Bartlesville, OK (US); Ta Yen Ching, Danville, CA (US); R. Shawn Childress, Bartlesville, OK (US); Jeffrey S. Fodor, Bartlesville, OK (US); Kent E. Mitchell, Bartlesville, OK (US); Howard S. Ferrell, Caney, KS (US)

(73) Assignee: Chevron Phillips Chemical Company LP, The Woodlands, TX (US)

(21) Appl. No.: 13/477,209

(22) Filed: May 22, 2012

(51) Int. Cl. C08K 3/04; C08K 3/16; C08L 81/04; B82Y 30/00

(52) U.S. Cl. 524/438; 524/796; 524/881; 524/609; 524/500; 977/748

(57) ABSTRACT

The present application relates reinforced poly(arylene sulfide) compositions and processes of producing the reinforced poly(arylene sulfide) compositions. The reinforced poly(arylene sulfide compositions can be prepared by blending the reinforcing agent with the poly(arylene sulfide) or by including the reinforcing agent in the process to produce the poly(arylene sulfide). Reinforcing agents which can be utilized are graphenes (e.g., single-walled carbon nanotubes). The inclusion of the graphene reinforcing agent in the poly(arylene sulfide) composition affects the crystallization properties and/or the conductivity of the melt processed poly(arylene sulfide) compositions.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

This disclosure generally relates to a composition comprising improved polymer compositions. More specifically this disclosure relates to polymer composite compositions and methods to produce them.

### BACKGROUND

Reinforced polymer compositions have broad applications in articles of manufacture. Reinforcing agents are often introduced to the polymers in an effort to improve one or more properties of the composition. However, challenges that plague the preparation of a reinforced polymer composition include the ability to adequately disperse the reinforcing agent in the polymer matrix and good adhesion of the polymer matrix to the reinforcing agent. These challenges hinder the preparation reinforced polymer compositions such as carbon-nanotube reinforced polymer composites. Thus it would be desirable to develop improved methodologies for the preparation of reinforced polymer compositions. Additionally, it would be desirable to develop novel reinforced polymer compositions having improved physical and/or mechanical properties.

### SUMMARY OF THE INVENTION

This disclosure provides for process of preparing a reinforced poly(arylene sulfide) composition comprising a poly(arylene sulfide) and a reinforcing agent. Additionally, this disclosure provides for process of preparing a reinforced poly(phenylene sulfide) composition comprising a poly(phenylene sulfide) and a reinforcing agent.

In an aspect, the process of preparing a reinforced poly(arylene sulfide) composition can comprise a) contacting i) a reinforcing agent composition comprising a graphene, a functionalized graphene, or a combination thereof, ii) at least one halogenated aromatic compound having two halogens, iii) a sulfur compound, and iv) a first polar organic compound to form a poly(arylene sulfide) and b) recovering the reinforced poly(arylene sulfide) composition. In an embodiment, the reinforcing agent composition can further comprise a liquid medium; or alternatively, the reinforcing agent composition can be essentially devoid of a liquid medium. In an embodiment, the reinforcing agent composition can be prepared by contacting the graphene, the functionalized graphene, or a combination thereof with a liquid medium prior to contacting the reinforcing agent with the at least one halogenated aromatic compound having two halogens, the sulfur compound, and the first polar organic compound. In an embodiment, the reinforcing agent composition can comprise a fullerene, a functionalized fullerene, or any combination thereof; or alternatively, the reinforcing agent composition can comprise a carbon nanotube, a functionalized nanotube, or any combination thereof. In some embodiments, the poly(arylene sulfide) can be poly(phenylene sulfide). In some embodiments wherein a liquid medium can be utilized, the liquid medium can comprise poly(arylene sulfide) oligomer (or poly(phenylene sulfide) oligomers). In some embodiments, the functionalized graphene can comprise a halogen. In some embodiments, the recovered reinforced poly(arylene sulfide) composition can be melt processed.

In another aspect, the process of producing reinforced poly(arylene sulfide) composition can comprise a) contacting i) a poly(arylene sulfide) composition comprising a poly(arylene sulfide) and ii) a reinforcing agent composition comprising a graphene to form a mixture and b) melt processing the mixture. In yet another aspect, the process of forming a reinforced poly(arylene sulfide) composition can comprise a) contacting 1) a mixture formed from a first mixture comprising i) a first poly(arylene sulfide) composition comprising a poly(arylene sulfide), and ii) a reinforcing agent composition comprising a graphene, 2) a second poly(arylene sulfide) composition comprising a poly(arylene sulfide) to form a second mixture, and b) melt processing the second mixture. In some embodiments, the poly(arylene sulfide) composition (first, second, or any other) can be essentially devoid of a liquid medium; alternatively, the reinforcing agent composition can be essentially devoid of a liquid medium; or alternatively, the poly(arylene sulfide) composition (first, second, or any other) can be essentially devoid of a liquid medium and the reinforcing agent composition can be essentially devoid of a liquid medium. In some embodiments, the poly(arylene sulfide) composition (first, second, or any other) can further comprise a liquid medium; alternatively, the reinforcing agent composition can further comprise a liquid medium; or alternatively, the poly(arylene sulfide) composition (first, second, or any other) can further comprise a liquid medium and the reinforcing agent composition can further comprise a liquid medium.

In a further aspect, the process of producing a reinforced poly(arylene sulfide) composition can comprise A) contacting i) a poly(arylene sulfide) composition comprising a poly(arylene sulfide) and a first liquid medium and ii) a reinforcing agent composition comprising a graphene and a second liquid medium, B) dispersing the reinforcing agent composition into the poly(arylene sulfide) composition to form a first mixture, and C) removing the first liquid medium and the second liquid medium from the first mixture to form a second mixture comprising the poly(arylene sulfide) and the graphene. In some embodiments, the second mixture can be melt processed.

In an embodiment wherein a reinforcing agent composition can comprise a reinforcing agent and a liquid medium, the process can further comprise a step of dispersing the reinforcing agent in the liquid medium. In some embodiments, reinforcing agent can be dispersed in the liquid medium utilizing ultrasonication, mechanical stirring, or a combination thereof; alternatively, ultrasonication; or alternatively, mechanical stirring.

In an embodiment, the reinforced poly(arylene sulfide) composition can be melt processed. In some embodiments, the melt processed reinforced poly(arylene sulfide) composition can have a property selected from (1) a cold crystallization temperature lower than a cold crystallization temperature of an otherwise similar poly(arylene sulfide) composition lacking the reinforcing agent, (2) a melt crystallization temperature higher than a melt crystallization temperature of an otherwise similar poly(arylene sulfide) composition lacking the reinforcing agent, (3) a crystallization temperature window larger than a crystallization temperature window of an otherwise similar poly(arylene sulfide) composition lacking the reinforcing agent, (4) a crystallization window ratio greater than a crystallization window ratio of an otherwise similar poly(arylene sulfide) composition lacking the reinforcing agent, and (5) a surface electrical resistivity that is less than a surface electrical resistivity of an otherwise similar poly(arylene sulfide) composition lacking the reinforcing agent.

### DESCRIPTION OF THE DRAWINGS

FIG. 1 provides a heat flow (W/g) versus temperature (° C.) of the scanning differential calorimetry analysis of the non-acid-washed reinforced poly(phenylene sulfide) composition produced in Example 1.

FIG. 2 provides a heat flow (W/g) versus temperature (° C.) of the scanning differential calorimetry analysis of the non-acid-washed poly(phenylene sulfide) composition (which does not contain a reinforcing agent) produced in Example 3.

FIG. 3 provides a graph of the melt crystallization temperature (T_{mc}) as a function of the percentage of single-walled nanotubes present in the reinforced poly(phenylene sulfide) compositions produced in Example 13.

FIG. 4 provides a graph of the surface resistivity of the reinforced poly(phenylene sulfide) compositions produced in Example 13.

FIG. 5 shows the 64× micrographs of thin films prepared from the reinforced poly(phenylene sulfide) compositions produced in Example 13.

### NOTATION AND NOMENCLATURE

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

A chemical “group” can be defined or described according to how that group is formally derived from a reference or “parent” compound, for example, by the number of hydrogen atoms that are formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, an “alkenyl group” by removing one hydrogen atom from an alkene, or an alkynyl group by removing one hydrogen atom from an alkyne, while an “alkylene group” “alkenylene group” or “alkynylene group” formally can be derived by removing two hydrogen atoms from an alkane, alkene, or alkyne, respectively. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials which have three or more hydrogen atoms, as necessary for the situation, removed from and alkane. Throughout, the disclosure that a substituent or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents as understood by one of ordinary skill in the art.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—CN), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri” within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

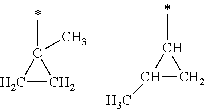

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon-the methylene group in diphenylmethane; oxygen-diphenyl ether; nitrogen-triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

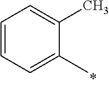

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g. the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g. the 2 carbon atom in the phenyl group of 6-phenylbenzofuran) and a heteroarene group if the removed hydrogen carbon came from a heteroaromatic ring or ring system carbon atom (e.g. the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g. a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphtyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

The term “liquid medium” and its derivatives, whenever used in this specification and claims, refer to a material which is liquid at ambient temperature and atmospheric pressure. Additionally, the term “liquid medium” and its derivatives, whenever used in this specification and claims, refers to a material in which another material is dispersed and/or a material which wets a solid material. Further, it should be noted that the “liquid medium” is a liquid material which can be substantially removed (to less than 1,000 ppm by weight) from the composition at a later stage in the process and which does not serve a purpose in the final composition produced (e.g., a liquid fire retardant which can be added to a composition can be a liquid but would not be considered a “liquid medium” because the fire retardant serves a purpose in the final composition) and/or serve a particular purpose in producing an article (pellets, fibers, or molded piece, among others) from the material (e.g., a lubricant—internal or external—utilized to produce pellets or a molded piece. It should be noted that the material which is dispersed in the “liquid medium” and/or is wetted by the “liquid medium” does not have to be dissolved by or solubilized by the “liquid medium.”

The term “essentially devoid of liquid medium” and its derivatives whenever used in this specification and claims refer to a composition containing less than 1000 ppm by weight of the liquid medium.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

### DETAILED DESCRIPTION

Disclosed herein are compositions comprising a polymer and a reinforcing agent, hereinafter termed reinforced polymer composition. The polymer can comprise any polymer compatible with the disclosed processes and materials. The reinforcing agent can comprise any reinforcing agent compatible with the polymer and disclosed process. The reinforced polymer compositions produced as described herein can exhibit improvements in one or more physical and/or mechanical properties when compared to an otherwise similar polymer compositions lacking the reinforcing agent.

In an embodiment, the reinforced polymer composition can comprise a polymer. The polymer can be a homopolymer or a copolymer. A polymer suitable for use in the present disclosure can be any polymer compatible with the processes and materials disclosed herein. Examples of polymers suitable for use in the present disclosure include without limitation poly(arylene sulfide)s, polyphenylene oxides, polyesters, nylon, epoxies, polyamides, or combinations thereof. In an embodiment, the polymer can comprise, or consist essentially of, a poly(arylene sulfide). In other embodiments, the polymer can comprise, or consist essentially of, a poly(phenylene sulfide). The polymer can in any form. For example, the form of the polymer can be as a raw polymer, a cured polymer, or a polymer processed (e.g., melt processed, among other processed forms) into an easily handled form such as pellets; alternatively, a raw polymer; alternatively, a cured polymer, or a processed polymer.

Generally, poly(arylene sulfide) is a polymer comprising a —(Ar—S)— unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified the poly(arylene sulfide) can include any isomeric relationship of the sulfide linkages in polymer; e.g. when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, the poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example, from 5 to 99 mole percent, 30 to 70 mole percent, or 70 to 95 mole percent of the —(Ar—S)— unit. Other ranges for the poly(arylene sulfide) units are readily apparent from the present disclosure. Poly(arylene sulfide) containing less than 100 percent —(Ar—S)— can further comprise one or more units having structure

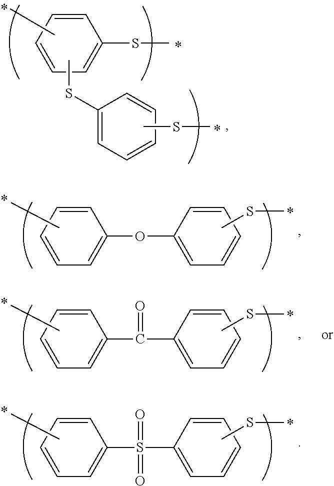

In an embodiment, the arylene sulfide unit can be represented by Formula I.

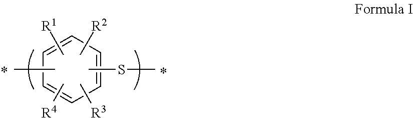

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, a aralkyl group or a substitute aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Some examples of suitable poly(arylene sulfide) polymers include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetra-methylphenylene sulfide), poly(butylcyclohexylphenylene sulfide), poly(hexyldodecylphenylene sulfide), poly(octadecylphenylene sulfide), poly(phenyphenylene), poly(tolylphenylene sulfide), poly(benzyl-phenylene sulfide), poly[octyl-4-(3-methylcyclopentyl)phenylene sulfide], and any combination thereof.

In an embodiment the reinforced polymer composition can comprise poly(phenylene sulfide). In an aspect, poly(phenylene sulfide) is a polymer comprising at least 70, 80, 90, or 95 mole percent para-phenylene sulfide units. In another embodiment, the poly(arylene sulfide) can contain up to 50, 70, 80, 90, 95, or 99 mole percent para-phenylene sulfide units. In some embodiments, poly(phenylene sulfide) can contain from any minimum mole percent of the para-phenylene sulfide unit disclosed herein to any maximum mole percent of the para-phenylene sulfide unit disclosed herein; for example, from 70 to 99 mole percent, 70 to 95 mole percent, or 80 to 95 mole percent of the —(Ar—S)— unit. Other ranges for the para-phenylene sulfide units are readily apparent from the present disclosure. The structure for the para-phenylene sulfide unit can be represented by Formula II.

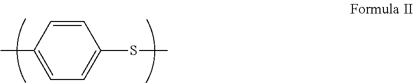

Poly(phenylene sulfide) can comprise up to 30, 20, 10, or 5 mole % of units selected from ortho-phenylene sulfide group, meta-phenylene sulfide groups, substituted phenylene sulfide groups, phenylene sulfone groups, substituted phenylene sulfide groups, and a group having structure

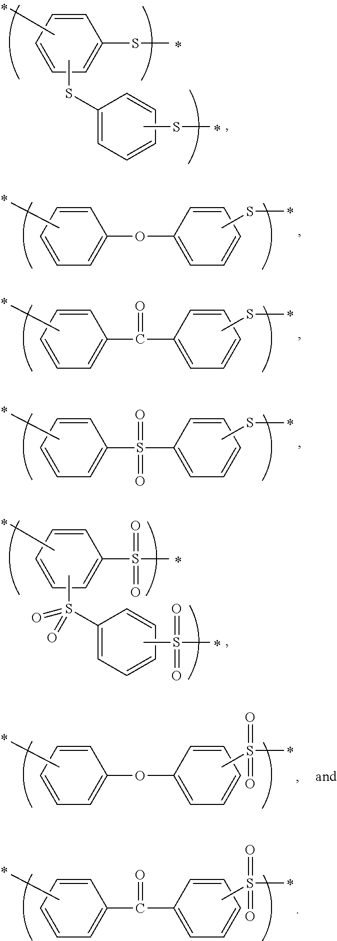

In other embodiments, poly(phenylene sulfide) can comprise up to up to 30, 20, 10, or 5 mole % of units selected from the group having the structures

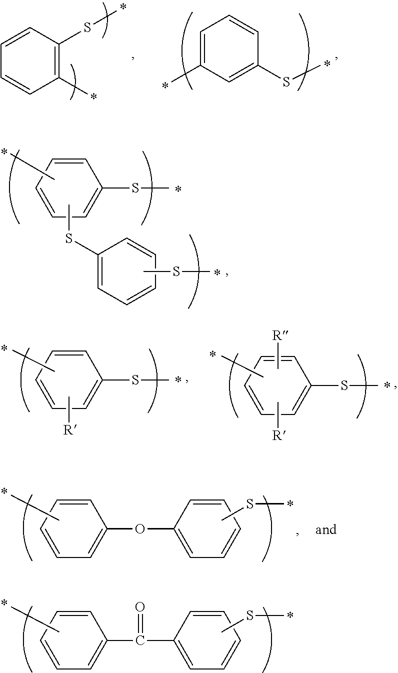

wherein R′ and R″ can be independently selected from any arylene substituent group disclosed herein for a poly(arylene sulfide). In other embodiments, poly(phenylene sulfide) can comprise up to 30, 20, 10, or 5 mole % of units selected from the group having the structures

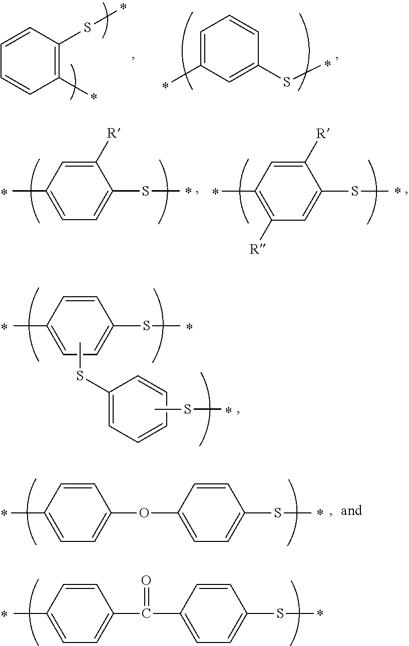

wherein R′ and R″ can be independently selected from any arylene substituent group disclosed herein for a poly(arylene sulfide). In other embodiments, poly(phenylene sulfide) can comprise up to up to 30, 20, 10, or 5 mole % of units selected from the group having the structures

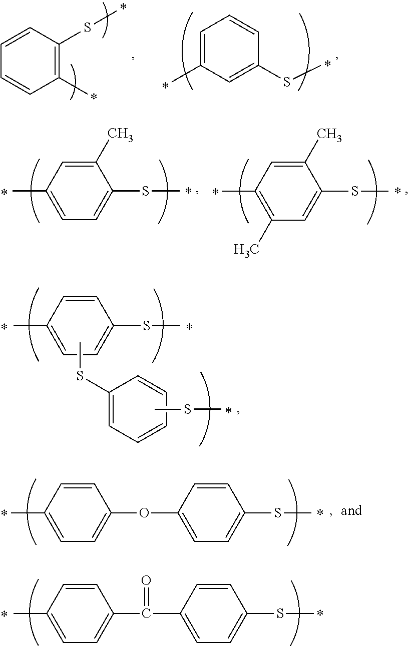

The poly(phenylene sulfide) molecular structure can readily form a thermally stable crystalline lattice, giving poly(phenylene sulfide) a semi-crystalline morphology with a high crystalline melting point ranging from about 265° C. to about 315° C. Because of its molecular structure, poly(phenylene sulfide) also can tend to char during combustion, making the material inherently flame resistant. Further, poly(phenylene sulfide) may not typically dissolve in solvents at temperatures below about 200° C.

Poly(phenylene sulfide) is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4,-trichlorobenzene, among others).

Similarly, poly(phenylene sulfide) can be produced by contacting at least one para-dihalobenzene compound, a sulfur compound, and a polar organic compound to form the poly(phenylene sulfide). In an embodiment, the process to produce the poly(phenylene sulfide) can further comprise recovering the poly(phenylene sulfide). In some embodiments, the poly(phenylene sulfide) can be formed under polymerization conditions capable of forming the poly(phenylene sulfide). When producing poly(phenylene sulfide) other dihaloaromatic compounds can also be present so long as the produced poly(phenylene sulfide) conforms to the poly(phenylene sulfide) structural features described herein. For example, in an embodiment, the poly(phenylene sulfide) can be prepared utilizing substituted para-dihalobenzene compounds, halogenated aromatic compounds having greater than two halogen atoms (e.g., 1,2,4-trichlorobenzene or substituted or a substituted 1,2,4-trichlorobenzene, among others). Methods of poly(phenylene sulfide) production are disclosed in U.S. Pat. No. 3,919,177, U.S. Pat. No. 3,354,129, U.S. Pat. No. 4,038,261, U.S. Pat. No. 4,038,262, U.S. Pat. No. 4,038,263, U.S. Pat. No. 4,064,114, U.S. Pat. No. 4,116,947, U.S. Pat. No. 4,282,347, U.S. Pat. No. 4,350,810, and U.S. Pat. No. 4,808,694.

Halogenated aromatic compounds having two halogens which can be employed to produce the poly(arylene sulfide) can be represented by Formula III.

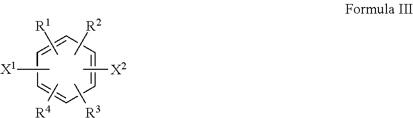

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³, and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichlorobenzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of poly(phenylene sulfide) can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of poly(phenylene sulfide) can be, comprise, or consist essentially of, p-dichlorobenzene.

In some embodiments, the synthesis of the poly(phenylene sulfide) can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited, sulfur sources which can be employed in the synthesis of the poly(arylene sulfide) (or poly(phenylene sulfide)) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) (or poly(phenylene sulfide)) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other suitable sulfur sources are disclosed in U.S. Pat. No. 3,919,177.

In an embodiment, a process for the preparation of poly(arylene sulfide) (or poly(phenylene sulfide)) can utilize a sulfur source which can be, comprise, or consist essentially of, an alkali metal bisulfide. In such embodiments, a reaction mixture for preparation of the poly(arylene sulfide) (or poly(phenylene sulfide)) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) (or poly(phenylene sulfide)) can be prepared by combining sodium hydrosulfide (NaSH) and sodium hydroxide (NaOH) in an aqueous solution followed by dehydration (or alternatively by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O [symbol] NaSH+NaOH

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when sodium sulfide is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing. Stoichiometrically, the overall reaction equilibrium may appear to follow the equation:

NMP+Na₂S+H₂O [symbol] CH₃NH₂CH₂CH₂CH₂CO₂Na(SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) (or a poly(phenylene sulfide)) can comprise a polar organic compound which can function to keep the dihaloaromatic compounds, sulfur source, and growing poly(arylene sulfide) (or poly(phenylene sulfide)) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N′-ethylene-dipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds for use in embodiments of the present disclosure can be found in D. R. Fahey and J. F. Geibel, Polymeric Materials Encyclopedia, Vol. 8, (Boca Raton, CRC Press, 1996), pages 6506-6515).

In an embodiment, processes for the preparation of a poly(arylene sulfide) (or a poly(phenylene sulfide)) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) (or poly(phenylene sulfide)) further can comprise an alkali metal carboxylate.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

General conditions for the production of poly(arylene sulfides) (e.g., poly(phenylene sulfide)) are generally described in U.S. Pat. Nos. 5,023,315; 5,245,000; 5,438,115; and 5,929,203. Although specific mention can be made in this disclosure and the disclosures incorporated by reference herein to material produced using the “quench” termination process it is contemplated that other processes (e.g., “flash” termination process) can be employed for the preparation of a poly(arylene sulfide) or a poly(phenylene sulfide). It is contemplated that a poly(arylene sulfide) or a poly(phenylene sulfide) obtained from process other than the quench termination process can be suitably employed in the methods and compositions of this disclosure.

Generally, the ratio of reactants employed in the polymerization process to produce a poly(arylene sulfide) (or a poly(phenylene sulfide)) can vary widely. However, the typical equivalent ratio of the halogenated aromatic compound having two halogens to sulfur compound can be in the range of 0.8 to 2; alternatively, 0.9 to 1.5; or alternatively, from 0.95 to 1.3. The amount of polyhalo-substituted aromatic compound optionally employed as a reactant can be any amount to achieve the desired degree of branching to give the desired poly(arylene sulfide) melt flow. Generally, up to about 0.02 moles of polyhalo-substituted aromatic compound per mole of halogenated aromatic compound having two halogens can be employed. If an alkali metal carboxylate is employed as a molecular weight modifying agent, the mole ratio of alkali metal carboxylate to dihaloaromatic compound(s) can be within the range of 0.02 to 4; alternatively, 0.05 to 3; or alternatively, from 0.1 to 2.

The amount of polar organic compound employed in the process to prepare the poly(arylene sulfide) (or poly(phenylene sulfide)) can vary over a wide range during the polymerization. However, the molar ratio of polar organic compound to the sulfur compound is typically within the range of 1 to 10. If a base, such as sodium hydroxide, is contacted with the polymerization reaction mixture, the molar ratio is generally in the range of 0.5 to 4 moles per mole of sulfur compound.

The components of the reaction mixture can be contacted with each other in any order. Some of the water, which can be introduced with the reactants, can be removed prior to polymerization. In some instances the water can be removed in a dehydration process. For example, in instances where a significant amount of water is present (e.g., more than 0.3 moles of water per mole of sulfur compound) water can be removed in a dehydration process. The temperature at which the polymerization can be conducted can be within the range of 170° C. (347° F.) to 450° C. (617° F.); alternatively, within the range of 200° C. (392° F.) to 285° C. (545° F.). The reaction time can vary widely, depending, in part, on the reaction temperature, but is generally within the range of 10 minutes to 3 days; alternatively, within a range of 1 hour to 8 hours. The reactor pressure need be only sufficient to maintain the polymerization reaction mixture substantially in the liquid phase. Such pressure will can be in the range of 0 psig to 400 psig; alternatively, in the range of 30 psig to in the range of 300 psig; or alternatively, in the range of 100 psig to 250 psig.

The polymerization can be terminated by cooling the reaction mixture (removing heat) to a temperature below that at which substantial polymerization takes place. In some instances the cooling of the reaction mixture also begins the process to recover the poly(arylene sulfide) as the poly(arylene sulfide) (e.g., poly(phenylene sulfide)) can precipitate from solution at temperatures less than 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from 235° C. to 185° C. Generally, poly(arylene sulfide) precipitation can impede further polymerization.

The poly(arylene sulfide) reaction mixture can be cooled using a variety of methods. In an embodiment, the polymerization can be terminated by the flash evaporation of the solvent (e.g., the polar organic compound, water, or a combination thereof) from the poly(arylene sulfide) reaction mixture. Processes for preparing poly(arylene sulfide) (e.g., poly(phenylene sulfide)) utilizing solvent flash evaporation to terminate the reaction can be referred to as a flash termination process. In other embodiments, the polymerization can be terminated by adding a liquid comprising, or consisting essentially of, 1) water, 2) polar organic compound, or 3) a combination of water and polar organic compound (alternatively water; or alternatively, polar organic compound) to the poly(arylene sulfide) reaction mixture and cooling the poly(arylene sulfide) (e.g., poly(phenylene sulfide)) reaction mixture. In yet other embodiments, the polymerization can be terminated by a solvent(s) other than water or the polar organic compound to the poly(arylene sulfide) reaction mixture and cooling the poly(arylene sulfide) (e.g., poly(phenylene sulfide)) reaction mixture. Processes for preparing poly(arylene sulfide) (e.g., poly(phenylene sulfide)) which utilize the addition of water, polar organic compound, and/or other solvent(s) to terminate the reaction can be referred to as a quench termination process. The cooling of the reaction mixture can be facilitated by the use of reactor jackets or coil. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

Once the poly(arylene sulfide) (or the poly(phenylene sulfide)) has precipitated from solution, a the particulate poly(arylene sulfide) (or particulate poly(phenylene sulfide)) can be recovered from the reaction mixture slurry by any process capable of separating a solid precipitate from a liquid. It should be noted, that the process to produce the poly(arylene sulfide) (or the poly(phenylene sulfide)) can form a by-product alkali metal halide. The by-product alkali metal halide can be removed during process steps utilized to recover the poly(arylene sulfide) (or the poly(phenylene sulfide)). Procedures which can be utilized to recover the poly(arylene sulfide) from the reaction mixture slurry can include, but is not limited to, i) filtration, ii) washing the poly(arylene sulfide) with a liquid (e.g., water), or iii) dilution of the reaction mixture with liquid (e.g., water) followed by filtration and washing the poly(arylene sulfide) (or the poly(phenylene sulfide)) with a liquid (e.g., water). For example, in a non-limiting embodiment, reaction mixture slurry can be filtered to recover the precipitated poly(arylene sulfide) (or the precipitated poly(phenylene sulfide)) and the recovered precipitate (containing poly(arylene sulfide) or poly(phenylene sulfide), and by-product alkali metal halide) can be slurried in a liquid (e.g., water) and subsequently filtered to remove the alkali metal halide by-product (and/or other liquid soluble impurities). Generally, the steps of slurring the poly(arylene sulfide) (or the poly(phenylene sulfide)) with a liquid followed by and filtration to recover the poly(arylene sulfide) (or the poly(phenylene sulfide)) can occur as many time as necessary to obtain a desired level of poly(arylene sulfide) (or poly(phenylene sulfide)) purity.

It should be noted that when using the quench termination process, liquid poly(arylene sulfide) oligomers (or the poly(phenylene sulfide) oligomers) can be isolated from the reaction mixture. These poly(arylene sulfide) oligomers (or the poly(phenylene sulfide) oligomers) can be recycled into the production of the poly(arylene sulfide) (or the poly(phenylene sulfide)). Alternatively, all or a portion of the poly(arylene sulfide) oligomers (or the poly(phenylene sulfide) oligomers) can be utilized as a liquid medium (or a portion of the liquid medium for the reinforcing agent (or functionalized reinforcing agent. Generally, the poly(arylene sulfide) oligomers (or the poly(phenylene sulfide) oligomers) can be found in the filtrate when the reaction mixture is filtered to separate the poly(arylene sulfide) (or the poly(phenylene sulfide)) from the reaction mixture. The filtrate(s) obtained from the filtering of the reaction mixture (and optionally, the washing of the poly(arylene sulfide) or the poly(phenylene sulfide)) can be decanted to recover the poly(arylene sulfide) oligomers (or the poly(phenylene sulfide) oligomers). The poly(arylene sulfide) oligomers (or the poly(phenylene sulfide) oligomers) can be optionally washed and/or filtered to further purify the poly(arylene sulfide) oligomers (or the poly(phenylene sulfide) oligomers). Additional details and methods for obtaining poly(arylene sulfide) oligomers (or the poly(phenylene sulfide) oligomers) are provided in U.S. Pat. No. 4,730,034, U.S. Pat. No. 5,354,841, and U.S. Pat. No. 5,440,009.

The recovered poly(arylene sulfide) (or poly(phenylene sulfide)) can undergo post recovery processing. For example, the recovered poly(arylene sulfide) (or poly(phenylene sulfide)) can be treated with an aqueous acid solution and/or can be treated with an aqueous metal cation solution. Additionally, the recovered poly(arylene sulfide) (or poly(phenylene sulfide)) can be dried to remove liquid adhering to the particulate recovered poly(arylene sulfide) (or poly(phenylene sulfide)). Generally, the poly(arylene sulfide) (or the poly(phenylene sulfide)) which can undergo post recovery processing can be i) the poly(arylene sulfide) (or the poly(phenylene sulfide)) recovered from the reaction mixture or ii) the recovered poly(arylene sulfide) (or the recovered poly(phenylene sulfide)) which was been wash with a liquid (e.g., water) and filtered to remove the alkali metal halide by-product (and/or other liquid soluble impurities). The poly(arylene sulfide) (or the poly(phenylene sulfide)) which can undergo post recovery processing can either be liquid wet or dry; alternatively, liquid wet; or alternatively, dry.

Acid treatment can comprise a) contacting the poly(arylene sulfide) (or the poly(phenylene sulfide)) with water to form a poly(arylene sulfide) slurry (or the poly(phenylene sulfide) slurry), b) contacting the poly(arylene sulfide) slurry (or the poly(phenylene sulfide) slurry) with an acidic compound to form a mixture, c) heating the mixture in substantial absence of a gaseous oxidizing atmosphere to an elevated temperature below the melting point of the poly(arylene sulfide) (or the poly(phenylene sulfide)), and d) recovering an acid treated poly(arylene sulfide) (or an acid treated poly(phenylene sulfide)); alternatively, a) contacting the poly(arylene sulfide) (or the poly(phenylene sulfide)) with aqueous solution comprising an acidic compound to form a mixture, b) heating the mixture in substantial absence of a gaseous oxidizing atmosphere to an elevated temperature below the melting point of the poly(arylene sulfide) (or the poly(phenylene sulfide)), and c) recovering an acid treated poly(arylene sulfide) (or an acid treated poly(phenylene sulfide)). The acidic compound can be any organic acid or inorganic acid which is water soluble which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture can range from 0.01 wt. % to 10 wt. %, from 0.025 wt. % to 5 wt. %, or from 0.075 wt. % to 1 wt. % based on total amount of water in the mixture. The amount of poly(arylene sulfide) (or the poly(phenylene sulfide)) present in the mixture can range from 1 wt. % to 50 wt. %, from 5 wt. % to 40 wt. %, or from 10 wt. % to 30 wt. % based upon the total weight of the mixture. Generally, the elevated temperature below the melting point of the poly(arylene sulfide) (or the poly(phenylene sulfide)) can range from 165° C. to 10° C., from 150° C. to 15° C., or from 125° C. to 20° C. below the melting point of the poly(arylene sulfide) (or the poly(phenylene sulfide)); or alternatively, can range from 175° C. to 275° C., or from 200° C. to 250° C. Additional features of the acid treatment process are provided in U.S. Pat. No. 4,801,644.

Generally, the metal cation treatment can comprise a) contacting the poly(arylene sulfide) (or the poly(phenylene sulfide)) with water to form a poly(arylene sulfide) slurry (or the poly(phenylene sulfide) slurry), b) contacting the poly(arylene sulfide) slurry (or the poly(phenylene sulfide) slurry) with an Group 1 or Group 2 metal compound to form a mixture, c) heating the mixture in substantial absence of a gaseous oxidizing atmosphere to an elevated temperature below the melting point of the poly(arylene sulfide) (or the poly(phenylene sulfide)), and d) recovering a metal cation treated poly(arylene sulfide) (or a metal cation treated poly(phenylene sulfide)); alternatively, a) contacting the poly(arylene sulfide) (or the poly(phenylene sulfide)) with aqueous solution comprising a Group 1 or Group 2 metal compound to form a mixture, b) heating the mixture in substantial absence of a gaseous oxidizing atmosphere to an elevated temperature below the melting point of the poly(arylene sulfide) (or the poly(phenylene sulfide)), and c) recovering a metal cation treated poly(arylene sulfide) (or a metal cation treated poly(phenylene sulfide)). The Group 1 or Group 2 metal compound can be any organic Group 1 or Group 2 metal compound or inorganic Group 1 or Group 2 metal compound which is water soluble under the conditions of the acid treatment; alternatively, an organic Group 1 or Group 2 metal compound which is water soluble under the conditions of the acid treatment; or alternatively, an inorganic Group 1 or Group 2 metal compound which is water soluble under the conditions of the acid treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture can range from 50 ppm to 10,000 ppm, 75 ppm to 7500 ppm, or 100 ppm to 5,000 ppm. Generally, the amount of the Group 1 or Group 2 metal compound is by the total weight of the mixture. The amount of poly(arylene sulfide) (or the poly(phenylene sulfide)) present in the mixture can range from 10 wt. % to 60 wt. %, from 15 wt. % to 55 wt. %, or from 20 wt. % to 50 wt. % based upon the total weight of the mixture. Generally, the elevated temperature below the melting point of the poly(arylene sulfide) (or the poly(phenylene sulfide)) can range from 165° C. to 10° C., from 150° C. to 15° C., or from 125° C. to 20° C. below the melting point of the poly(arylene sulfide) (or the poly(phenylene sulfide)); or alternatively, can range from 125° C. to 275° C., or from 1500° C. to 250° C. Additional features of the acid treatment process are provided in EP patent publication 0103279 A1.

Once the poly(arylene sulfide) (or the poly(phenylene sulfide) has been acid treated and/or metal cation treated, the acid treated and/or metal cation treated poly(arylene sulfide) (or the poly(phenylene sulfide) can be isolated. Generally, the process/steps for isolating the acid treated and/or metal cation treated poly(arylene sulfide) (or the poly(phenylene sulfide) can be the same steps as those for recovering and/or isolating the poly(arylene sulfide) (or the poly(phenylene sulfide) from the reaction mixture.

Once the poly(arylene sulfide) (or the poly(phenylene sulfide) has been isolated (either in raw, acid treated, metal cation treated, or acid treated and metal cation treated form), the isolated poly(arylene sulfide) (or the poly(phenylene sulfide) can be dried and optionally cured.

Generally, the poly(arylene sulfide) (or the poly(phenylene sulfide) drying process can be performed at any temperature which can substantially dry the poly(arylene sulfide) (or the poly(phenylene sulfide). The drying process should result in substantially no oxidative curing of the poly(arylene sulfide) (or the poly(phenylene sulfide). For example, if the drying process is conducted at a temperature at or above 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below 100° C., the drying process can be facilitated by performing the drying at a pressure less than atmospheric pressure so the liquid component can be vaporized from the poly(arylene sulfide) (or the poly(phenylene sulfide). When the drying of the poly(arylene sulfide) (or the poly(phenylene sulfide) drying is performed below 100° C., the presence of a gaseous oxidizing atmosphere will generally not result in a detectable curing of the poly(arylene sulfide) (or the poly(phenylene sulfide). Generally, air is considered to be a gaseous oxidizing atmosphere.

Poly(arylene sulfide)s (or poly(phenylene sulfide)s) can be cured by subjecting the poly(arylene sulfide) (or the poly(phenylene sulfide)) to an elevated temperature, below its melting point, in the presence of gaseous oxidizing atmosphere. Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from 1° C. to 130° C. below the melting point of the poly(arylene sulfide) (or the poly(phenylene sulfide)), 10° C. to 110° C. below the melting point of the poly(arylene sulfide) (or the poly(phenylene sulfide)), or 30° C. to 85° C. below the melting point of the poly(arylene sulfide) (or the poly(phenylene sulfide)).

In an embodiment, the reinforced polymer composition can comprise, or consist essentially of, a polymer (any disclosed herein) and a reinforcing agent. Any reinforcing agent compatible with the polymer utilized can be employed as a reinforcing agent. In an embodiment, the reinforcing agent can comprise, or consist essentially of, a graphene. In some embodiments, the graphene can be graphite, or a fullerene, or any combination thereof; alternatively, graphite; or alternatively, a fullerene. In an embodiment, the fullerene can be a buckyball, a carbon nanofiber, or any combination thereof; alternatively, a buckyball; or alternatively, a carbon nanofiber. In some embodiment, the carbon nanofiber can be a carbon nanotube.

Generally, buckyballs which can be utilized as the reinforcing agent can have any number of carbon atoms which can form a buckyball. In an embodiment, the buckyball can be, comprise, or consist essentially of, a C₂₀ buckyball to a C₁₀₀₀ buckyball; alternatively, a C₂₀ buckyball to a C₆₀₀₀ buckyball; alternatively, a C₂₀ buckyball to a C₂₀₀₀ buckyball; or alternatively, a C₂₀ buckyball to a C₁₀₀₀ buckyball; or alternatively, a C₂₀ buckyball to a C₅₀₀ buckyball. In some embodiments, the buckyball which can be utilized as the reinforcing agent can be, comprise, or consist essentially of, a C₂₀ buckyball, a C₆₀ buckyball, a C₇₂ buckyball, a C₈₄ buckyball, a C₉₆ buckyball, a C₁₀₈ buckyball, a C₁₂₀ buckyball, or any combination thereof; alternatively, a C₂₀ buckyball; alternatively, a C₆₀ buckyball; alternatively, a C₇₂ buckyball; alternatively, a C₈₄ buckyball; alternatively, a C₉₆ buckyball; alternatively, a C₁₀₈ buckyball; or alternatively, a C₁₂₀ buckyball.

In an embodiment, the reinforcing agent can be introduced into the polymer by covalently bonding the reinforcing agent to the polymer. In such embodiments, the reinforcing agent can contain a functional group (a functionalized reinforcing agent) which can participate in the reaction to form polymer (e.g., a poly(arylene sulfide); or alternatively, a poly(phenylene sulfide)). Without being limited to theory, it is believed that such method can produce a reinforced polymer composition wherein the reinforcing agent can be covalently bonded to the polymer (e.g., a poly(arylene sulfide); or alternatively, a poly(phenylene sulfide)). In should be noted that, in such scenarios, all of the functionalized reinforcing agent does not have to be covalently bonded to the polymer. Additionally, it should be noted that the process for producing the functionalized reinforcing agent, may not introduce the functional group into each individual molecule of reinforcing agent. Consequently, the produced reinforced polymer composition can comprise, i) polymer (e.g., a poly(arylene sulfide); or alternatively, a poly(phenylene sulfide)), ii) polymer wherein the reinforcing agent is covalently bonded to the polymer (e.g., a poly(arylene sulfide); or alternatively, a poly(phenylene sulfide)), iii) non-functionalized reinforcing agent, iv) functionalized reinforcing agent, or v) any combination thereof. Mixtures of the polymer (e.g., a poly(arylene sulfide); or alternatively, a poly(phenylene sulfide)) wherein the reinforcing agent and/or functionalized reinforcing agent are not covalently bound can be referred to as an admixture. Such reinforced polymer compositions can display enhanced dispersion of the reinforcing agent due to the ability of the reinforcing agent to form covalent linkages with the polymer.

In an embodiment, the reinforcing agent can be, comprise, or consist essentially of, a functionalized graphene. In some embodiments, the functionalized graphene can be, comprise, or consist essentially of, functionalized graphite, or a functionalized fullerene, or any combination thereof; alternatively, functionalized graphite; or alternatively, a functionalized fullerene. In an embodiment, the functionalized fullerene can be, comprise, or consist essentially of, a functionalized buckyball, a functionalized carbon nanofiber, or any combination thereof; alternatively, a functionalized buckyball; or alternatively, a functionalized carbon nanofiber. In some embodiment, the functionalized carbon nanofiber can be, comprise, or consist essentially of, a functionalized carbon nanotube. The functionalized buckyball can be a buckyball having any carbon number disclosed herein which has been functionalized (hereafter a functionalized Cₓ buckyball; or alternatively, a functionalized Cₓ buckyball to functionalized C_{y} buckyball. In some embodiments, the functionalized carbon nanotube can be, comprise, or consist essentially of, a functionalized single-walled carbon nanotube (also referred to as a functionalized SWNT), a multi-wall carbon nanotube (also referred to as a functionalized MWNT), or any combination thereof; alternatively, a functionalized single-walled carbon nanotube; or alternatively, a functionalized multi-wall carbon nanotube. As described herein, processes for producing the functionalized reinforcing agent may not introduce the functional group into each individual molecule of reinforcing agent. Consequently, the recitation of a functionalized reinforcing agent refers to reinforcing agent mixture which can contain functionalized reinforcing agent and nonfunctionalized reinforcing agent.

The functional group of any functionalized reinforcing agent described herein can be any functional group capable of reacting in a manner to covalently bond it with the polymer (e.g., a poly(arylene sulfide); or alternatively, a poly(phenylene sulfide)). Alternatively, the functional group of any functionalized reinforcing agent described herein can be any functional group capable of participating in the polymerization to form a reinforced polymer composition (e.g., a reinforced poly(arylene sulfide) composition; or alternatively, a reinforced poly(phenylene sulfide) composition) comprising reinforcing agent covalently bonded to the polymer. It should be noted that when the reinforcing agent can bond with the polymer, not all of the polymer molecules may have a reinforcing agent bound to it. Consequently, the reinforced polymer composition can comprise polymer molecules having a reinforcing agent bound to it and polymer molecules having no reinforcing agent bound to it.

In an embodiment, the functional group of the functionalized reinforcing agent (any general or specific disclosed herein) can be, comprise, or consist essentially of, halogens, ester groups, amide groups, amine groups, nitro groups, hydroxy groups, or any combination thereof; alternatively, halogens; alternatively, ester groups; alternatively, amide groups; alternatively, amine groups; alternatively, nitro groups; or alternatively, hydroxy groups. In some embodiments, the functionalized reinforcing agent (any general or specific disclosed herein) can include a substituted aromatic group; alternatively, a functionalized aryl group; or alternatively, functionalized phenyl group. In an embodiment, the functional group(s) of the substituted aromatic group, substituted aryl group, or substituted phenyl group can be any functional group disclosed herein as a functional group for the functionalized reinforcing material. In some non-limiting embodiments, the functionalized reinforcing agent can include a halogenated aromatic group; alternatively, a halogenated aryl group; or alternatively, a halogenated phenyl group. Other functionalized aromatic groups, aryl groups, and aryl group which can be utilized as the functional group on the functionalized graphene are readily apparent from the present disclosure.

In an embodiment wherein the polymer is a poly(arylene sulfide) or poly(phenylene sulfide), the reinforcing agent can comprise a functionalized reinforcing agent that includes a halogen (any disclosed herein) or a halogenated aromatic group (any general or specific disclosed herein); alternatively, a halogen; or alternatively, a halogenated aromatic group. Functionalized reinforcing agents that include a halogen group or a halogenated aromatic group are disclosed herein and can be utilized without limitation as the functional reinforcing group utilized when the polymer is a poly(arylene sulfide) or poly(phenylene sulfide). Without wishing to be limited by theory, it is thought that functionalized reinforcing agent including halogen group or a halogenated aromatic group can provide the reactivity needed to incorporate the desired amount of reinforcing agent into the polymer (e.g., poly(arylene sulfide) or poly(phenylene sulfide)). The halogen or the halogenated aromatic group can be selected to provide the reactivity to incorporate the desired amount of reinforcing agent into the polymer.

As a non-limiting example, a functionalized graphene having a halogenated phenyl group can be prepared by reacting a phenol or thiophenol with a halogenated graphene to form a graphene having a phenyl group and then halogenating the graphene having a phenyl group to form the functionalized graphene having a halogenated phenyl group. Equations representative of such reactions for a general graphene are set forth below:

F-Graphene→Graphene-O—C₆H₅→Graphene-O—C₆H₄—X

F-Graphene→Graphene-S—C₆H₅→Graphene-S—C₆H₄—X,

wherein F-Graphene is a fluorinated graphene and X is a general halogen. Equations representative of such reactions for single-walled nanotubes are set forth below:

F-SWNT→SWNT-O—C₆H₅→SWNT-O—C₆H₄—X

F-SWNT→SWNT-S—C₆H₅→SWNT-S—C₆H₄—X,

wherein F-SWNT is a fluorinated single-walled carbon nanotube and X is a halogen. In some embodiments, X can be fluorine, chlorine, bromine, or iodine; alternatively, fluorine; alternatively, chlorine; alternatively, bromine; or alternatively, iodine. The preparation of other general and specific functionalized graphenes is readily apparent from this disclosure.

Any suitable methodology can be employed for functionalization of the graphenes. Such methodologies include for example oxidation by corona discharge, ozone oxidation, high energy particle bombardment, ultrasound, oxidation using nitric or sulfuric acids, and metal-halide coupling reactions such as lithium reduction in liquid ammonia followed by addition of a halogenated compound.

In an embodiment, the reinforcing agent can be present in the reinforced polymer composition (as an admixture, covalently bonded to the polymer, or a combination thereof) in any amount. In some embodiments, the reinforcing agent can be present in the reinforced polymer composition (as an admixture, covalently bonded to the polymer, or a combination thereof) in an amount that provides a desired property; or alternatively, a desired effect. In an embodiment, the minimum reinforcing agent to polymer weight ratio that can be present in the reinforced polymer composition (as an admixture, covalently bonded to the polymer, or a combination thereof) can be 0.0001:1; alternatively, 0.0003:1; alternatively, 0.0005:1; alternatively, 0.0008:1; alternatively, 0.001:1; alternatively, 0.002:1; alternatively, 0.003:1; alternatively, 0.004:1; alternatively, 0.005:1; alternatively, 0.0075:1; alternatively, 0.01:1; alternatively, 0.0125:1; alternatively, 0.015:1; alternatively, 0.02:1; alternatively, 0.04:1; alternatively, 0.06:1; alternatively, 0.08:1; or alternatively, 0.1:1. In an embodiment, the maximum amount of reinforcing agent that can be present in the reinforced polymer composition (as an admixture, covalently bonded to the polymer, or a combination thereof) can be 0.25:1; alternatively, 0.2:1; alternatively, 0.15:1; alternatively, 0.1:1; alternatively, 0.075:1; alternatively, 0.05:1; alternatively, 0.045:1; alternatively, 0.04:1; alternatively, alternatively, 0.035:1; alternatively, 0.03:1; alternatively, 0.0275:1; alternatively, 0.025:1; alternatively, 0.02:1; alternatively, 0.015:1; or alternatively, 0.01:1. In some embodiments, the amount of reinforcing agent that can be present in the reinforced polymer composition (as an admixture, covalently bonded to the polymer, or a combination thereof) can range from any minimum value disclosed herein to any maximum value disclosed herein. In some non-limiting embodiments, the amount of reinforcing agent that can be present in the reinforced polymer composition (as an admixture, covalently bonded to the polymer, or a combination thereof) can range from 0.0001:1 to 0.25:1; alternatively, from 0.04:1 to 0.25:1; alternatively, from 0.04:1 to 0.15:1; alternatively, from 0.04 to 0.1:1; alternatively, from 0.06:1 to 0.15:1; alternatively, from 0.005:1 to 0.05:1, alternatively from 0.005:1 to 0.03:1: alternatively, from 0.01:1 to 0.02:1; alternatively, from 0.0001:1 to 0.01:1; alternatively, from 0.0005:1 to 0.01:1; alternatively, from 0.001:1 to 0.01:1; alternatively, from 0.003:1 to 0.01:1. Other ranges for amount of reinforcing agent that can be present in the reinforced polymer composition (as an admixture, covalently bonded to the polymer, or a combination thereof) are readily apparent from the present disclosure.

Generally, the process of preparing the reinforced polymer composition can comprise introducing the reinforcing agent (any disclosed herein) with the reagents utilized to form the polymer, during the polymerization to form the polymer, or after forming the polymer. Dependent upon particular goals any one method can be utilized individually; or alternatively, two or more methods can be utilized in combination. For example, the process of preparing the reinforced polymer composition can comprise having the reinforcing agent present during the formation of the polymer and then adding additional reinforcing agent after the polymer has been formed and/or isolated.

In an aspect, the present application relates to a process of preparing a reinforced polymer composition comprising i) contacting a reinforcing agent and a polymer to form a mixture and ii) melt processing the mixture to form a reinforced polymer composition. In an embodiment, the reinforcing agent can be a part of a composition (a reinforcing agent composition) comprising the reinforcing agent; alternatively, part of a composition comprising, or consisting essentially of, the reinforcing agent and a liquid medium (general, first, second, or other); or alternatively, part of a composition comprising the reinforcing a reinforcing agent composition) wherein the composition is essentially devoid of a liquid medium. In an embodiment, the polymer can be a part of a composition (a polymer composition) comprising the polymer; alternatively, part of a composition comprising, or consisting essentially of, the polymer and a liquid medium (general, first, second, or other); or alternatively, part of a composition comprising the polymer wherein the composition is essentially devoid of a liquid medium. Polymers, reinforcing agents, and liquid mediums are described herein. Any aspect or embodiments of the herein described can be utilized further describe any particular process of preparing a reinforced polymer composition described herein which utilizes a polymers, reinforcing agent, and/or a liquid medium.

In an embodiment, the process of producing reinforced polymer composition can comprise a) contacting i) a polymer composition comprising, or consisting essentially of, a polymer and wherein the polymer composition is essentially devoid of a liquid medium, and ii) a reinforcing agent composition comprising, or consisting essentially of, a reinforcing agent (any described herein) and wherein the reinforcing agent composition is essentially devoid of a liquid medium, to form a mixture; and b) melt processing the mixture. In an embodiment, the process of producing the reinforced polymer composition can include steps for dispersing the reinforcing agent composition into the polymer composition prior to melt processing the mixture. Reinforcing agent to polymer weight ratios are described herein and these ratios can be utilized without limitation to further describe the process of producing reinforced polymer composition. Any process, steps, and/or apparatus capable of dispersing a one substantially dry material into a second substantially dry material known to those having ordinary skill in the art can be utilized to disperse the reinforcing agent (or the reinforcing agent composition devoid of a liquid medium) into the polymer (or the polymer composition devoid of a liquid medium).

In an embodiment, the process of producing reinforced polymer composition can comprise a) contacting i) a polymer composition comprising, or consisting essentially of, a polymer and a liquid medium, and ii) a reinforcing agent composition comprising, or consisting essentially of, a reinforcing agent and wherein the reinforcing agent composition is essentially devoid of a liquid medium, to form a mixture; and b) melt processing the mixture. In some embodiments, the process of producing the reinforced polymer composition can include steps for dispersing the polymer in the liquid medium. In other embodiments, the process of producing the reinforced polymer composition can include steps for dispersing the reinforcing agent composition in the polymer composition. In yet other embodiments, the process of producing the reinforced polymer composition can include steps for removing the liquid medium from the mixture prior to melt process the mixture. For example, in a non-limiting embodiment wherein the liquid medium is removed prior to melt processing the mixture, the process of producing reinforced polymer composition can comprise a) contacting i) a polymer composition comprising, or consisting essentially of, a polymer and a liquid medium, and ii) a reinforcing agent composition comprising, or consisting essentially of, a reinforcing agent and wherein the reinforcing agent composition is essentially devoid of a liquid medium, to form a first mixture, b) removing the liquid medium from the first mixture to form a second mixture essentially devoid of liquid medium, and c) melt processing the second mixture. Reinforcing agent to polymer weight ratios are described herein and these ratios can be utilized without limitation to further describe the process of producing reinforced polymer composition. Any process, steps, and/or apparatus capable of dispersing a substantially dry material into a liquid medium known to those having ordinary skill in the art can be utilized to disperse the polymer into the liquid medium. Any process, steps, and/or apparatus capable of dispersing a substantially dry material into a composition comprising a particulate material dispersed in a liquid medium known to those having ordinary skill in the art can be utilized to disperse the reinforcing agent (or the reinforcing agent composition devoid of a liquid medium) into the polymer composition comprising or consisting essentially, the polymer and a liquid medium. Processes, steps, and/or apparatuses for removing liquid medium from a polymer composition (e.g., a poly(arylene sulfide) composition or a poly(phenylene sulfide) composition) including a liquid) are described herein and any aspect or embodiment of these steps can be utilized to further describe the process of producing reinforced polymer composition.

In an embodiment, the process of producing reinforced polymer composition can comprise a) contacting i) a polymer composition comprising, or consisting essentially of, a polymer and a first liquid medium, and ii) a reinforcing agent composition comprising, or consisting essentially of, a reinforcing agent and a second liquid medium, to form a mixture; and b) melt processing the mixture. In some embodiments, the process of producing the reinforced polymer composition can include steps for dispersing the polymer in the first liquid medium. In some embodiments, the process of producing the reinforced polymer composition can include steps for dispersing the reinforcing agent in the second liquid medium. In some embodiments, the process of producing the reinforced polymer composition can include steps for dispersing the polymer in the first liquid medium and steps for dispersing the reinforcing agent in the second liquid medium. In other embodiments, the first liquid medium and the second liquid medium can be the same; or alternatively, the first liquid medium can be different from the second liquid medium. In other embodiments, the process of producing the reinforced polymer composition can include steps for dispersing the reinforcing agent composition in the polymer composition. In yet other embodiments, the process of producing the reinforced polymer composition can include steps for removing the liquid medium (first and/or second) from the mixture prior to melt process the mixture. For example, in a non-limiting embodiment wherein the liquid medium (first and second) is removed prior to melt process the mixture, the process of producing reinforced polymer composition can comprise a) contacting i) a polymer composition comprising, or consisting essentially of, a polymer and a first liquid medium, and ii) a reinforcing agent composition comprising, or consisting essentially of, a reinforcing agent and a second liquid medium, to form a first mixture, b) removing the first liquid medium and the second liquid medium from the first mixture to form a second mixture essentially devoid of liquid medium, and c) melt processing the second mixture. In embodiments wherein the first liquid medium is different from the second liquid medium, the first liquid medium and the second liquid medium can be removed using different and/or separate steps; or alternatively, the first liquid medium and the second liquid medium can be removed simultaneously. Reinforcing agent to polymer weight ratios are described herein and these ratios can be utilized without limitation to further describe the process of producing reinforced polymer composition.

Any process, steps, and/or apparatus capable of dispersing a substantially dry material into a liquid medium known to those having ordinary skill in the art can be utilized to disperse the polymer into the liquid medium. In an embodiment wherein the polymer is a poly(arylene sulfide) (or alternatively, a poly(phenylene sulfide)), an aqueous solution washed poly(arylene sulfide) composition (or alternatively, a aqueous solution washed poly(phenylene sulfide) composition) from the production of poly(arylene sulfide) (or alternatively, a poly(phenylene sulfide)) can be utilized as the polymer composition comprising a polymer and a liquid medium. In such instances, no further dispersing may be needed. Steps for dispersing the reinforcing agent in the liquid medium are described herein and any aspect or embodiment of these steps can be utilized without limitation to further describe the process of producing reinforced polymer composition. Any process, steps, and/or apparatus capable of dispersing one composition comprising a first particulate material dispersed in a first liquid into a second composition comprising second particulate material dispersed in a second liquid known to those having ordinary skill in the art can be utilized to disperse the reinforcing agent composition comprising a reinforcing agent and a second liquid medium into the polymer composition comprising, or consisting essentially of a polymer and a first liquid medium. Processes, steps, and/or apparatuses for removing liquid medium from a polymer composition (e.g., a poly(arylene sulfide) composition or a poly(phenylene sulfide) composition) including a liquid) are described herein and any aspect or embodiment of these steps can be utilized to further describe the process of producing reinforced polymer composition.

When a reinforcing composition comprising a reinforcing agent and a liquid medium is to contacted with a polymer (or polymer composition), the amount of liquid medium in the formed mixture may become detrimental to forming a dispersed mixture. In these instances in can beneficial to remove some of the liquid medium (first and/or second) from the resulting mixture before all of reinforcing agent composition is contacted with the polymer composition. Consequently, in an embodiment, the process of preparing a reinforced can include steps for removing a portion (or alternatively, all) of the liquid medium from the mixture. It should be noted that the liquid medium can be removed concurrently with the contacting of the reinforcing agent composition with the polymer composition; or alternatively, the contacting of the reinforcing agent composition with the polymer composition can be discontinued, steps for removing the liquid medium (first and/or second) implemented and discontinued, and then the contacting of the reinforcing agent composition with the polymer composition continued. In the later case, the discontinuation of the contacting of the reinforcing agent composition with the polymer composition, implementation of liquid removal steps, and continuation of the contacting of the reinforcing agent composition with the polymer composition cycle can occur as many times as necessary to provide the final mixture. In a non-limiting example, the process of producing reinforced polymer composition can comprise 1) performing at least one cycle of a) contacting i) a polymer composition comprising, or consisting essentially of, a polymer and a first liquid medium, and ii) a reinforcing agent composition comprising, or consisting essentially of, a reinforcing agent and a second liquid medium, to form an intermediate mixture, b) removing a portion of the first liquid medium, second liquid medium, or a combination thereof from the intermediate mixture, 2) contacting a final portion of the of the reinforcing composition with the polymer composition to form a first mixture, 3) removing the first liquid medium and the second liquid medium to form a second mixture, and c) melt processing the second mixture. Other embodiments are readily apparent from embodiments and aspects of the reinforcing agent composition, polymer composition, first liquid medium, second liquid medium, and other features disclosed herein. Processes, steps, and/or apparatuses for removing a liquid and/or drying a composition comprising, or consisting essentially of, a particulate polymer and liquid are described herein (e.g., methods for removing a liquid from and or drying a poly(arylene sulfide composition or a polyphenylene sulfide composition). These processes, steps, and/or apparatuses can be utilized without limitation to remove all or a portion of the liquid medium from a mixture including the polymer, the reinforcing agent, and the liquid medium (first second, or other).

In aspects which utilize a liquid medium, the liquid medium (general, first, second, or other) which can be utilized in the polymer composition and/or the reinforcing agent composition can be, comprise, or consist essentially of, water, a polar organic compound, or any combination thereof. In some embodiments, the liquid medium (general, first, second, or other) which can be utilized in the polymer composition and/or the reinforcing agent composition can be, comprise, or consist essentially of, water; or alternatively, a polar organic compound. When both the polymer composition and the reinforcing agent composition utilize a liquid medium, the liquid medium utilized for the polymer composition and the reinforcing agent composition are independent of each other. In some embodiments, the liquid medium utilized in the polymer composition and the liquid medium utilized in the reinforcing agent composition can be the same. In other embodiments, the liquid medium utilized in the polymer composition and the liquid medium utilized in the reinforcing agent composition can be different. In yet other embodiments, the liquid medium utilized in the polymer composition and the liquid medium utilized in the reinforcing agent composition can share a common component (e.g., one liquid medium can be water and the other liquid medium can be a mixture of water and polar organic compound).

In an embodiment wherein the polymer composition comprises, or consists essentially of, a polymer and a liquid medium (general, first, second, or any other), the polymer composition can comprise, or consist essentially of, the polymer and water; alternatively, the polymer and a polar organic compound; or alternatively, the polymer, water, and a polar organic compound. Generally, when the polymer composition includes a liquid medium (general, first, second, or any other), the amount of liquid medium in the polymer composition can be any amount which can facilitate the contacting of the polymer and the reinforcing agent and/or any amount which can facilitate dispersing the reinforcing agent (or reinforcing agent composition) within the polymer composition. In an embodiment, the minimum weight ratio of polymer to liquid medium in the polymer composition comprising, or consisting essentially of, a polymer and a liquid medium can be 1:1; alternatively, 2.5:1; alternatively, 3:1; alternatively, 4:1; alternatively, 5:1; alternatively, 6:1: or alternatively 7:1. In an embodiment, the maximum weight ratio of polymer to liquid medium in the polymer composition comprising, or consisting essentially of, a polymer and a liquid medium can be 100:1; alternatively, 50:1; alternatively, 25:1; alternatively, 20:1; alternatively, 15:1; alternatively, 13:1; or alternatively, 10:1. In some embodiments, the weight ratio of polymer to liquid medium in the polymer composition comprising, or consisting essentially of, a polymer and a liquid medium can range from any minimum polymer to liquid medium ratio disclosed herein to any maximum polymer to liquid medium ratio disclosed herein. For example, in some non-limiting embodiments, the weight ratio of polymer to liquid medium in the polymer composition comprising, or consisting essentially of, a polymer and a liquid medium can range from 1:1 to 100:1; alternatively, range from 4:1 to 25:1; alternatively, range from 5:1 to 15:1; alternatively, 6:1 to 15:1; or alternatively, 7:1 to 15:1. Other ranges for the weight ratio of polymer to liquid medium which can be utilized are readily apparent from the present disclosure.

In an embodiment wherein the reinforcing agent composition comprises, or consists essentially of, a reinforcing agent and a liquid medium (general, first, second, or any other), the reinforcing agent composition can comprise, or consist essentially of, a reinforcing agent and water; alternatively, a reinforcing agent and a polar organic compound; or alternatively, a reinforcing agent, water, and a polar organic compound. In some embodiments wherein the reinforcing agent composition includes a liquid medium (any described herein), the reinforcing agent composition can further comprise a dispersant (or a dispersant composition). When the reinforcing agent includes a dispersant (or dispersant composition), the reinforcing agent composition can comprise, or consisting essentially of, the reinforcing agent, a liquid medium (general, first, second, or other), and a dispersant (or a dispersant composition). Consequently, in embodiment wherein the reinforcing agent composition comprises, or consists essentially of, a reinforcing agent, a liquid medium (general, first, second, or any other), and a dispersant (or a dispersant composition), the reinforcing agent composition can comprise, or consist essentially of, the reinforcing agent water, and a dispersant (or a dispersant composition); alternatively, the reinforcing agent, a polar organic compound, and a dispersant (or a dispersant composition); or alternatively, the reinforcing agent, water, a polar organic compound, and a dispersant (or a dispersant composition). Dispersant and dispersant compositions are disclosed herein and can be utilized without limitation to further describe the reinforcing agent composition can comprise, or consisting essentially of, the reinforcing agent, a liquid medium (general, first, second, or other), and a dispersant (or a dispersant composition).

In some instances, dispersant (or a component of a dispersant composition) can be detrimental to the process to prepare the reinforced polymer composition (e.g., when the reinforcing agent is present the dispersant or dispersant composition may be detrimental to the formation of the polymer), the properties of reinforced polymer composition, the processing of the reinforced polymer composition into an article, and/or properties or performance of a finished article utilizing the polymer. Consequently, in some aspects and embodiments wherein the reinforcing agent includes a liquid medium, the reinforcing agent composition can be essentially devoid of a dispersant (or dispersant composition).

Generally, when the reinforcing agent composition includes a liquid medium (general, first, second, or any other), the amount of liquid medium in the reinforcing agent composition can be any amount which can facilitate the contacting of the reinforcing agent composition and the polymer composition and/or any amount which can facilitate dispersing the reinforcing agent within the polymer composition. In an embodiment, the minimum weight ratio of reinforcing agent to liquid medium in any reinforcing agent composition including a reinforcing agent and a liquid medium described herein can be 0.001:1; alternatively, 0.002:1; alternatively, 0.004:1; alternatively, 0.006:100; alternatively, 0.008:1; alternatively, 0.01:1; alternatively, 0.012:1; alternatively, 0.014:1; or alternatively, 0.015:1. In an embodiment, the maximum weight ratio of reinforcing agent to liquid medium in any reinforcing agent composition including a reinforcing agent and a liquid medium described herein can be 0.25:1; alternatively, 0.2:1; alternatively, 0.18:1; alternatively, 0.16:1; alternatively, 0.14:1; alternatively, 0.12:1; alternatively, 0.1:1; alternatively, 0.08:1 alternatively, 0.06:1; or alternatively, 0.04:1. In some embodiments, the weight ratio of reinforcing agent to liquid medium in any reinforcing agent composition including a reinforcing agent and a liquid medium described herein can range from any minimum reinforcing agent to liquid medium ratio disclosed herein to any maximum reinforcing agent to liquid medium ratio disclosed herein. For example, in some non-limiting embodiments, the weight ratio of reinforcing agent to liquid medium in any reinforcing agent composition including a reinforcing agent and a liquid medium described herein can range from 0.001:1 to 0.25:1; alternatively, from 0.001:1 to 0.18:1; alternatively, from 0.001:1 to 0.25:1; alternatively, from 0.002:1 to 0.16:1; alternatively, from 0.004:1 to 0.1:1; or alternatively, from 0.006:1 to 0.08:1.

In aspects where the reinforcing agent composition includes a dispersant (or a dispersant composition), the weight ratio of the dispersant (or dispersant composition) to the reinforcing agent can be any ratio which facilitates the dispersion of the reinforcing agent into the liquid medium. In some embodiments, the minimum weight ratio of dispersant (or dispersant composition) to the reinforcing agent can be 0.05:1; alternatively, 0.1:1; alternatively, 0.25:1; alternatively, 0.5:1; alternatively, 0.75:1; or alternatively, 1:1. In other embodiments, the maximum weight ratio of dispersant (or dispersant composition) to the reinforcing agent can be 500:1; alternatively, 250:1; alternatively, 150:1; alternatively, 100:1; alternatively, 75:1; alternatively, 50:1; alternatively, 25:1; alternatively, 10:1; alternatively, 7.5:1; alternatively, 5:1 or alternatively 2.5:1. In yet other embodiments, the weight ratio of dispersant (or dispersant composition) to the reinforcing agent can range from any minimum weight ratio of dispersant (or dispersant composition) to the reinforcing agent disclosed herein to any maximum weight ratio of dispersant (or dispersant composition) to the reinforcing agent disclosed herein. For example, in some non-limiting embodiments, the weight ratio of dispersant (or dispersant composition) to the reinforcing agent can range from 0.05:1 to 500:1; alternatively, from 0.25:1 to 100:1; alternatively, from 0.5:1 to 10:1; alternatively, from 0.1:1 to 5:1; or alternatively, 0.1 to 2.5:1. Other ranges of the weight ratio of dispersant (or dispersant composition) to the reinforcing agent are readily apparent from the present disclosure. Dispersant (and dispersant composition are disclosed herein and can be utilized without limitation to further describe the any reinforcing agent composition utilizing a dispersant (or dispersant composition) described herein and/or any process for producing a reinforced polymer composition utilizing a reinforcing agent composition including a dispersant (or dispersant composition). Process, steps, and/or apparatuses capable of dispersing a reinforcing agent into a liquid medium are described herein and can be utilized to describe forming a reinforcing agent composition including a reinforcing agent and the liquid medium.

Generally, the dispersing agent which can be utilized (either on its own or in a dispersing agent composition) can be any dispersing agent which can disperse the reinforcing agent in the selected liquid medium. For example when the reinforcing agent is a graphene (any general or specific graphene disclosed herein), the graphene can be dispersed in a liquid medium with Nanosperse AQ or Nanosperse AC. Other dispersing agents are readily known to those having skill in the art.

In an aspect wherein the reinforced polymer composition is a reinforced poly(arylene sulfide) composition, the process of preparing the reinforced poly(arylene sulfide) composition can comprise contacting a reinforcing agent (e.g., functionalized nanotubes, among others disclosed herein), at least one halogenated aromatic compound having two halogens, a sulfur compound, and a polar organic compound to form a poly(arylene sulfide). Generally, the reinforcing agent, the one halogenated aromatic compound having two halogens, the sulfur compound, the polar organic compound, and the poly(arylene sulfide) are independent elements of the process to prepare the reinforced poly(arylene sulfide) composition. The process of preparing the reinforced poly(arylene sulfide) composition can described using any aspect or embodiment of the reinforcing agent described herein, any aspect or embodiment of the halogenated aromatic compound having two halogens described herein, any aspect or embodiment of the sulfur compound described herein, any aspect or embodiment of the polar organic compound described herein, any aspect or embodiment of the poly(arylene sulfide) described herein, any aspect or embodiment of the process to prepare a poly(arylene sulfide) described herein, and/or any aspect or embodiment of the properties of the poly(arylene sulfide) composition described herein. Other aspects, and/or embodiments for producing the reinforced poly(arylene sulfide) composition are similar to the steps, aspects, and embodiments, for producing poly(arylene sulfide). These aspects, and embodiments, can be utilized without limitation to further described the process for producing the reinforced poly(arylene sulfide) composition. For example, the process of preparing reinforced poly(arylene sulfide) composition can further comprise recovering the reinforced poly(arylene sulfide) composition.

In an aspect wherein reinforced polymer composition is a reinforced poly(phenylene sulfide) composition the process to prepare the reinforced poly(phenylene sulfide) composition can comprise contacting a reinforcing agent (e.g., functionalized nanotubes, among others disclosed herein), at least one para-dihalobenzene compound, a sulfur compound, and a polar organic compound to form a poly(phenylene sulfide). Generally, the reinforcing agent, the para-dihalobenzene compound, the sulfur compound, the polar organic compound, and the poly(phenylene sulfide) are independent elements of the process to prepare the reinforced poly(phenylene sulfide) composition. The process of preparing the reinforced poly(phenylene sulfide) composition can described using any aspect or embodiment of the reinforcing agent described herein, any aspect or embodiment of the para-dihalobenzene compound described herein, any aspect or embodiment of the sulfur compound described herein, any aspect or embodiment of the polar organic compound described herein, any aspect or embodiment of the poly(phenylene sulfide) described herein, any aspect or embodiment of the process to prepare a poly(phenylene sulfide) described herein, and/or any aspect or embodiment of the properties of the poly(phenylene sulfide) composition described herein. Other aspects, and/or embodiments for producing the reinforced poly(phenylene sulfide) composition are similar to the aspects, and embodiments, for producing poly(arylene sulfide). These aspects, and embodiments, can be utilized without limitation to further described the process of producing the reinforced poly(phenylene sulfide) composition. For example, the process of preparing reinforced poly(phenylene sulfide) can further comprise recovering the reinforced poly(phenylene sulfide).

In an embodiment, the process to prepare the reinforced poly(arylene sulfide) composition (or the reinforced poly(phenylene sulfide) composition) can further comprise recovering the reinforced poly(arylene sulfide) composition (or recovering the reinforced poly(phenylene sulfide) composition). In some embodiments, the process to prepare the reinforced poly(arylene sulfide) composition (or the reinforced poly(phenylene sulfide) composition) can further comprise recovering the reinforced poly(arylene sulfide) composition (or the reinforced poly(phenylene sulfide) composition) and melt processing the recovered reinforced poly(arylene sulfide) composition (or melt processing the recovered reinforced poly(phenylene sulfide) composition). Generally the methods and/or steps for recovering the reinforced poly(arylene sulfide) composition (or the reinforced poly(phenylene sulfide) composition) are the same as the methods and/or steps for isolating a poly(arylene sulfide) (or a poly(phenylene sulfide)). Methods and steps for recovering the poly(arylene sulfide) (or the poly(phenylene sulfide)) and/or melt processing the poly(arylene sulfide) (or poly(phenylene sulfide)) are disclosed herein and can be utilized without limitation to further describe the process of preparing the reinforced poly(arylene sulfide) composition (or the reinforced poly(phenylene sulfide) composition).

In an aspect, the reinforcing agent (or functionalized reinforcing agent) contacted with the at least one halogenated aromatic compound having two halogens, the sulfur compound, and the polar organic compound (or at least one para-dihalobenzene compound, the sulfur compound, and the polar organic compound) can be part of a composition (a reinforcing agent composition, or a functionalized reinforcing agent composition). Reinforcing agent compositions are disclosed herein and these reinforcing agent compositions can be utilized in the process to produce a reinforced polymer composition by contacting a reinforcing agent composition, at least one halogenated aromatic compound having two halogens, a sulfur compound, and a polar organic compound (or at least one para-dihalobenzene compound, a sulfur compound, and a polar organic compound). Additionally, the herein described reinforcing agent composition can be a functionalized reinforcing agent composition and the functionalized reinforcing agent compositions can have the same compositional elements as the herein described reinforcing agent composition where the functionalized reinforcing agent replaces the reinforcing agent. Consequently, in some embodiments, the functionalized reinforcing agent composition can be utilized in the process to produce a reinforced polymer composition by contacting a functionalized reinforcing agent, at least one halogenated aromatic compound having two halogens, a sulfur compound, and a polar organic compound (or at least one para-dihalobenzene compound, a sulfur compound, and a polar organic compound).

In an aspect, the reinforcing agent (or functionalized reinforcing agent) can be contacted with the at least one halogenated aromatic compound having two halogens, the sulfur compound, and the polar organic compound (or at least one para-dihalobenzene compound, the sulfur compound, and the polar organic compound) in an amount to provide a reinforced poly(arylene sulfide) composition (or reinforced poly(phenylene sulfide) composition) having any desired amount of reinforcing agent disclosed herein. Desirable amounts of the reinforcing agent that can be present in the reinforced poly(arylene sulfide) composition (or reinforced poly(phenylene sulfide) composition) are provided herein and these amounts can be utilized, without limitation, to further describe the reinforced poly(arylene sulfide) composition (or the reinforced poly(phenylene sulfide) composition) and/or the process of preparing the reinforced poly(arylene sulfide) composition (or reinforced poly(phenylene sulfide) composition). One having ordinary skill in the art will recognize that the process steps occurring after forming the poly(arylene sulfide) (or the poly(phenylene sulfide)) can result in the loss of reinforcing agent (or functionalized reinforcing agent). Consequently, the amount of reinforcing agent (or functionalized reinforcing agent) that can be contacted with the at least one dihaloaromatic compound, the sulfur compound, and the polar organic compound (or at least one para-halogenated aromatic compound, the sulfur compound, and the polar organic compound) can be an amount in excess of the amount desired to be present in the reinforced poly(arylene sulfide) composition (or the reinforced poly(phenylene sulfide) composition) but would lead to the amount desired to be present in the reinforced poly(arylene sulfide) composition (or the reinforced poly(phenylene sulfide) composition). In an embodiment, the minimum amount of reinforcing agent (or functionalized reinforcing agent) contacted with the at least halogenated aromatic compound having two halogens, the sulfur compound, and the polar organic compound (or at least one para-halogenated aromatic compound, the sulfur compound, and the polar organic compound) can be at least 0 wt. %, 5 wt. %, 10 wt. %, 15 wt. %, 20 wt. %, 30 wt. %, 40 wt. %, or 50 wt. % in excess of the amount desired to be present in the reinforced poly(arylene sulfide) composition (or the reinforced poly(phenylene sulfide) composition). In an embodiment, the maximum amount of reinforcing agent (or functionalized reinforcing agent) contacted with the at least one halogenated aromatic compound having two halogens, the sulfur compound, and the polar organic compound (or at least one para-halogenated aromatic compound, the sulfur compound, and the polar organic compound) can be 100 wt. %, 90, wt. %, 80 wt. %, 70 wt. %, 60 wt. %, 50 wt. %, 40 wt. %, or 30 wt. % in excess of the amount desired to be present in the reinforced poly(arylene sulfide) composition (or the reinforced poly(phenylene sulfide) composition). In an embodiment, the amount of reinforcing agent (or functionalized reinforcing agent) contacted with the at least one halogenated aromatic compound having two halogens, the sulfur compound, and the polar organic compound (or at least one para-dihalobenzene compound, the sulfur compound, and the polar organic compound) can range from any minimum amount in excess of the amount desired to be present in the reinforced poly(arylene sulfide) composition (or the reinforced poly(phenylene sulfide) composition) disclosed herein to any maximum amount in excess of the amount desired to be present in the reinforced poly(arylene sulfide) composition (or the reinforced poly(phenylene sulfide) composition) disclosed herein. In some non-limiting embodiment, the amount of reinforcing agent (or functionalized reinforcing agent) contacted with the at least one halogenated aromatic compound having two halogens, the sulfur compound, and the polar organic compound (or at least one para-dihalobenzene compound, the sulfur compound, and the polar organic compound) can range from 0 wt. % to 100 wt. % in excess of the amount desired to be present in the reinforced poly(arylene sulfide) composition (or the reinforced poly(phenylene sulfide) composition); alternatively, range from 0 wt. % to 50 wt. % in excess of the amount desired to be present in the reinforced poly(arylene sulfide) composition (or the reinforced poly(phenylene sulfide) composition); alternatively, range from 10 wt. % to 50 wt. % in excess of the amount desired to be present in the reinforced poly(arylene sulfide) composition (or the reinforced poly(phenylene sulfide) composition); or alternatively, range from 10 wt. % to 40 wt. % in excess of the amount desired to be present in the reinforced poly(arylene sulfide) composition (or the reinforced poly(phenylene sulfide) composition). Other ranges for the amount of reinforcing agent (or functionalized reinforcing agent) contacted with the at least one halogenated aromatic compound having two halogens, the sulfur compound, and the polar organic compound (or at least one para-dihalobenzene compound, the sulfur compound, and the polar organic compound) are readily apparent from the present disclosure. Generally, the wt. % in excess of the amount desired to be present in the reinforced poly(arylene sulfide) composition (or the reinforced poly(phenylene sulfide) composition) is based upon the amount desired to be present in the reinforced poly(arylene sulfide) composition (or the reinforced poly(phenylene sulfide) composition).

In an aspect, the reinforcing agent (or functionalized reinforcing agent) is contacted with the at least one halogenated aromatic compound having two halogens, a sulfur compound, and a polar organic compound (or at least one para-dihalobenzene compound, the sulfur compound, and the polar organic compound) in amount to provide a desired property. Desired properties are described herein and these properties can be utilized to further describe the reinforced poly(arylene sulfide) composition (or reinforced poly(phenylene sulfide) composition) and/or the process to prepare the reinforced poly(arylene sulfide) composition (or reinforced poly(phenylene sulfide) composition).

It has been discovered that poly(arylene sulfide) oligomers (or alternatively, poly(phenylene sulfide) oligomers) can utilized as (or as a component of) the liquid medium. This discovery can lead to improvements in a process to produce a reinforced poly(arylene sulfide) composition (or poly(phenylene sulfide) composition) by including a reinforcing agent (or functionalized reinforcing agent) in the reaction mixture to form a poly(arylene sulfide) (or poly(phenylene sulfide). Consequently, in any embodiment wherein the reinforcing agent (or functionalized reinforcing agent) can include a liquid medium, the liquid medium can further comprise poly(arylene sulfide) oligomers (or poly(phenylene sulfide oligomers). Consequently, in an embodiment, the reinforcing agent composition (or a functionalized reinforcing agent composition) which can be contacted with the at least one halogenated aromatic compound having two halogens, the sulfur compound, and the polar organic compound (or at least one para-dihalobenzene compound, the sulfur compound, and the polar organic compound) can be, comprise, or consist essentially of, poly(arylene sulfide) oligomers (or poly(phenylene sulfide oligomers); alternatively, water and poly(arylene sulfide) oligomers (or poly(phenylene sulfide oligomers); alternatively, a polar organic compound (the same or different from that utilized to produce the poly(arylene sulfide or poly(phenylene sulfide)) and poly(arylene sulfide) oligomers (or poly(phenylene sulfide oligomers); or alternatively, water, a polar organic compound (the same or different from that utilized to produce the poly(arylene sulfide or poly(phenylene sulfide)), and poly(arylene sulfide) oligomers (or poly(phenylene sulfide oligomers).

It has additionally been discovered that the poly(arylene sulfide) oligomers (or poly(phenylene sulfide oligomers) can function like a dispersant for the reinforcing agent (or functionalized reinforcing agent. Consequently, when poly(arylene sulfide) oligomers (or poly(phenylene sulfide oligomers) are utilized as the liquid medium (or as a component of the liquid medium) for a reinforcing agent composition, no other dispersant may be necessary. Consequently, in some embodiments, the reinforcing agent composition (or functionalized reinforcing agent composition) can comprise a reinforcing agent (or a functionalized reinforcing agent), poly(arylene sulfide) oligomers (or poly(phenylene sulfide oligomers) and wherein the reinforcing agent composition is essentially devoid of dispersant (or dispersant composition); alternatively, comprise a reinforcing agent (or a functionalized reinforcing agent), water, poly(arylene sulfide) oligomers (or poly(phenylene sulfide oligomers) and wherein the reinforcing agent composition is essentially devoid of dispersant (or dispersant composition); alternatively, comprise a reinforcing agent (or a functionalized reinforcing agent), poly(arylene sulfide) oligomers (or poly(phenylene sulfide oligomers), and a polar organic compound, and wherein the reinforcing agent composition is essentially devoid of dispersant (or dispersant composition); or alternatively, comprise a reinforcing agent (or a functionalized reinforcing agent), poly(arylene sulfide) oligomers (or poly(phenylene sulfide oligomers), water, and a polar organic compound, and wherein the reinforcing agent composition is essentially devoid of dispersant (or dispersant composition). In some embodiments, wherein a polar organic compound is utilized in the liquid medium of a reinforcing agent composition (or functionalized reinforcing agent composition), the polar organic compound of the reinforcing agent composition (or functionalized reinforcing agent composition) can be the same as the polar organic compound utilized in the production of the poly(arylene sulfide) (or poly(phenylene sulfide)); or alternatively, the polar organic compound of the reinforcing agent composition (or functionalized reinforcing agent composition) and the polar organic compound utilized in the production of the poly(arylene sulfide) (or poly(phenylene sulfide)) can be different.

Generally, the weight ratio of the reinforcing agent (or functionalized reinforcing agent) to poly(arylene sulfide) oligomers (or poly(phenylene sulfide) oligomers) can depend on several factors and be dependent upon one or more user and/or process parameter which can be determined by one having ordinary skill in the art. Generally, the weight ratio of the poly(arylene sulfide) oligomers (or poly(phenylene sulfide) oligomers) to the liquid medium can depend on several factors and be dependent upon one or more user and/or process parameter which can be determined by one having ordinary skill in the art. Ratio of oligomers to liquid medium.

As provided herein, the process of preparing the reinforced polymer composition can comprise introducing the reinforcing agent (any disclosed herein) with the regents to form the polymer, during the polymerization to form the polymer, or after forming the polymer. Formation of a reinforced polymer composition can be facilitated by efficient dispersion of the reinforcing agent throughout the polymer. However, some reinforcing agents can tend to agglomerate or form bundles (e.g., carbon nanotubes or functionalized nanotubes, among others). As will be understood by the ordinarily skilled artisan, the tendency of some reinforcing agents to form bundles and the small size of some reinforcing material, the reinforcing agents can be insensitive to shear fields typically employed to disperse other materials (e.g., carbon black, chopped carbon fibers) in a polymer. Consequently, in some embodiments, the process of preparing a reinforced polymer composition can comprise subjecting a composition including the reinforcing agent to steps and/or processes that can increase the dispersion of the reinforcing agent in the composition and/or reduce the agglomeration of the reinforcing agent in the composition.

In an embodiment, a reinforcing agent composition (or a functionalized reinforcing agent composition) can be prepared as a step (or steps) in a process of preparing the reinforced polymer composition (e.g., a reinforced poly(arylene sulfide) composition or a reinforced poly(phenylene sulfide) composition). Generally, any step (or steps) and/or process (or processes) which can create a dispersion of the reinforcing agent (or functionalized reinforcing agent) in a selected media (any described herein) can be utilized in the process to prepare the reinforcing agent composition (or functionalized reinforcing agent composition). In an embodiment, the steps for preparing the reinforcing agent composition (or functionalized reinforcing agent composition) can comprise i) contacting the reinforcing agent (or functionalized reinforcing agent) with the selected media and ii) dispersing the reinforcing agent (or functionalized reinforcing agent) in the selected media.

In a non-limiting embodiment, the steps for preparing the reinforcing agent composition (or functionalized reinforcing agent composition) can comprise i) contacting the reinforcing agent (or functionalized reinforcing agent) and a liquid medium (any disclosed herein), and ii) dispersing the reinforcing agent in the liquid medium to form the reinforcing agent composition. In a non-limiting embodiment, the steps for preparing the reinforcing agent composition (or functionalized reinforcing agent composition) can comprise i) contacting the reinforcing agent (or functionalized reinforcing agent), a liquid medium (any disclosed herein), and a dispersant composition and ii) dispersing the reinforcing agent in the liquid medium to form the reinforcing agent composition. Materials which can be utilized as the liquid medium a disclosed herein and these materials can be utilized without limitation to form a reinforcing agent composition (or functionalized reinforcing agent composition). In embodiments wherein the reinforcing agent composition is contacted with the reagents utilized in the polymerization to form a poly(arylene sulfide) (or poly(phenylene sulfide)) and the reinforcing agent composition (or functionalized reinforcing agent) includes water, the polar organic compound, or any combination thereof, the reinforcing agent (or functionalized reinforcing agent) can be contacted with a portion of the water and/or a portion of the polar organic compound utilized to form the poly(arylene sulfide) (or poly(phenylene sulfide)).

In a non-limiting embodiment wherein the reinforcing agent (or functionalized reinforcing agent) is contacted with poly(arylene sulfide) oligomers (or poly(phenylene sulfide) oligomers), the reinforcing agent composition (or functionalized reinforcing agent composition) can be prepared by a) contacting a reinforcing agent (or functionalized reinforcing agent) and poly(arylene sulfide) oligomers (or poly(phenylene sulfide oligomers), b) dispersing the reinforcing agent (or functionalized reinforcing agent) and poly(arylene sulfide) oligomers (or poly(phenylene sulfide oligomers) to form a dispersed reinforcing agent mixture (or dispersed functionalized reinforcing agent mixture). In another non-limiting embodiment wherein the reinforcing agent (or functionalized reinforcing agent) is contacted with poly(arylene sulfide) oligomers (or poly(phenylene sulfide) oligomers), the reinforcing agent composition (or functionalized reinforcing agent composition) can be prepared by a) contacting a reinforcing agent (or functionalized reinforcing agent) and poly(arylene sulfide) oligomers (or poly(phenylene sulfide oligomers), b) dispersing the reinforcing agent (or functionalized reinforcing agent) and poly(arylene sulfide) oligomers (or poly(phenylene sulfide oligomers) to form a first dispersed reinforcing agent mixture (or first dispersed functionalized reinforcing agent mixture), c) contacting the first dispersed reinforcing agent mixture (or first dispersed functionalized reinforcing agent mixture) with a liquid medium, and d) dispersing the first dispersed reinforcing agent mixture (or dispersed functionalized reinforcing agent mixture) in the liquid medium to form the reinforcing agent composition (or functionalized reinforcing agent composition). Materials which can be utilized as the liquid medium are disclosed herein and these materials can be utilized without limitation to form a reinforcing agent composition (or functionalized reinforcing agent composition) including poly(arylene sulfide) oligomers (or poly(phenylene sulfide oligomers). In some embodiments wherein the reinforcing agent composition including poly(arylene sulfide) oligomers (or poly(phenylene sulfide oligomers) is contacted with the reagents utilized in the polymerization to form a poly(arylene sulfide) (or poly(phenylene sulfide)) and the reinforcing agent composition (or functionalized reinforcing agent) includes water, the polar organic compound, or any combination thereof, the reinforcing agent (or functionalized reinforcing agent) can be contacted with a portion of the water and/or a portion of the polar organic compound utilized to form the poly(arylene sulfide) (or poly(phenylene sulfide)).

Generally, any process, steps, and/or apparatus capable of dispersing the reinforcing agent (or functionalized reinforcing agent) into the selected medium (e.g., a liquid medium, poly(arylene sulfide) oligomers (or poly(phenylene sulfide oligomers), or a combination thereof, among others) can be utilized to form a dispersed reinforcing agent mixture (or dispersed functionalized reinforcing agent mixture). Additionally, any process, steps, and/or apparatus capable of dispersing the dispersed reinforcing agent mixture (or first dispersed functionalized reinforcing agent mixture) into the liquid medium can be utilized to form the reinforcing agent composition (or functionalized reinforcing agent composition).

In an aspect, the dispersing of the reinforcing agent (or functionalized reinforcing agent) into the selected medium (e.g., a liquid medium, poly(arylene sulfide) oligomers (or poly(phenylene sulfide oligomers), or a combination thereof, among others) can be performed by subjecting any reinforcing agent composition (or functionalized reinforcing agent composition) comprising the reinforcing agent described herein to ultrasonics. Generally, the ultrasonics can be applied in any known manner. For example, an ultrasonic probed can be inserted into a vessel containing, or which will contain, a mixture including the reinforcing agent (or the functionalized reinforcing agent) and the selected medium mixture. Alternatively, a vessel containing, or which will contain, a mixture including the reinforcing agent (or the functionalized reinforcing agent) and the selected medium can be placed into an ultrasonic bath. Other ultrasonic methods are known to those who have ordinary kill in the art and can be utilized to form reinforcing agent composition (or functionalized reinforcing agent composition) having a reinforcing agent (or functionalized reinforcing agent) dispersed in any medium described herein.

In a non-limiting embodiment wherein the reinforcing agent composition (or functionalized reinforcing agent composition) includes a liquid medium and wherein the reinforcing agent composition (or functionalized reinforcing agent composition) is devoid of poly(arylene sulfide) oligomers (or poly(phenylene sulfide oligomers), the formation of the dispersed reinforcing agent composition (or functionalized reinforcing agent composition) can comprise 1) contacting the reinforcing agent (or the functionalized reinforcing agent) and the liquid medium (any described herein) to form a mixture, and 2) subjecting the mixture to ultrasonics. In some embodiments, a dispersant (or a dispersant composition) can also be contacted with the reinforcing agent (or the functionalized reinforcing agent) and the liquid medium to form a mixture. It should be noted that the liquid medium and the reinforcing agent (or functionalized reinforcing agent) (or the liquid medium, the reinforcing agent (or functionalized reinforcing agent), and the dispersant (or dispersant composition)) do not necessarily have to be contacted before ultrasonication begins. For example, in some embodiments, the liquid medium (or the liquid medium and the dispersant (or dispersant composition)) can be under sonication prior to addition of the reinforcing agent (or the functionalized reinforcing agent); or alternatively, the reinforcing agent (or the functionalized reinforcing agent) and the liquid medium (or the reinforcing agent (or functionalized reinforcing agent), the liquid medium, and the dispersant (or the dispersant composition)) can be contacted and then sonicated.

In a non-limiting embodiment wherein the reinforcing agent composition (or functionalized reinforcing agent composition) includes of poly(arylene sulfide) oligomers (or poly(phenylene sulfide oligomers) the formation of the dispersed reinforcing agent composition (or functionalized reinforcing agent composition) can comprise 1) contacting the reinforcing agent (or the functionalized reinforcing agent) and the poly(arylene sulfide) oligomers (or poly(phenylene sulfide oligomers) to form a mixture, and 2) subjecting the mixture to ultrasonics. In some embodiments, the formation of the dispersed reinforcing agent composition (or functionalized reinforcing agent composition) can comprise a) contacting the reinforcing agent (or the functionalized reinforcing agent) and the poly(arylene sulfide) oligomers (or poly(phenylene sulfide oligomers) to form a first mixture, b) subjecting the mixture to ultrasonics to form a first dispersed reinforcing agent mixture (or first dispersed functionalized reinforcing agent mixture), c) contacting the first dispersed reinforcing agent mixture (or first dispersed functionalized reinforcing agent mixture) with a liquid medium, and d) dispersing the first dispersed reinforcing agent mixture (or dispersed functionalized reinforcing agent mixture) into the liquid medium to form the reinforcing agent composition (or functionalized reinforcing agent composition). Generally, the dispersing of the first dispersed reinforcing agent mixture (or dispersed functionalized reinforcing agent mixture) into the liquid medium can occur utilizing any process, steps, and/or apparatus capable of dispersing first dispersed reinforcing agent mixture (or dispersed functionalized reinforcing agent mixture) into the liquid medium (e.g., routine mixing and/or ultrasonics). In some embodiments, the dispersing of the first dispersed reinforcing agent mixture (or dispersed functionalized reinforcing agent mixture) into the liquid medium can be performed by subjecting a mixture including the first dispersed reinforcing agent mixture (or first dispersed functionalized reinforcing agent mixture) with a liquid medium to ultrasonics.

It should be noted that the poly(arylene sulfide) oligomers (or poly(phenylene sulfide oligomers) and the reinforcing agent (or functionalized reinforcing agent) do not necessarily have to be contacted before ultrasonication begins. For example, in some embodiments, the poly(arylene sulfide) oligomers (or poly(phenylene sulfide oligomers) can be under sonication prior to addition of the reinforcing agent (or functionalized reinforcing agent); or alternatively, the reinforcing agent (or functionalized reinforcing agent) and the poly(arylene sulfide) oligomers (or poly(phenylene sulfide oligomers) can be contacted and then sonicated. Additionally, the liquid medium and the first dispersed reinforcing agent mixture (or first dispersed functionalized reinforcing agent mixture) do not necessarily have to be contacted before ultrasonication begins. For example, in other embodiments, the liquid medium can be under sonication prior to addition of the first dispersed reinforcing agent mixture (or dispersed functionalized reinforcing agent mixture); alternatively, the first dispersed reinforcing agent mixture (or dispersed functionalized reinforcing agent mixture) can be under sonication prior to the addition of the liquid medium; or alternatively, the first dispersed reinforcing agent mixture (or dispersed functionalized reinforcing agent mixture) and the liquid medium can be contacted and then sonicated.

In an aspect, the process to produce a reinforced polymer composition can be part of a masterbatch process. In a masterbatch process, a first reinforced polymer composition (the masterbatch) can have a weight ratio of reinforcing agent to polymer that is greater than desired in a final reinforced polymer composition can combined with another composition comprising the polymer to provide final reinforced polymer composition having the desired weight ratio of reinforcing agent to polymer. In some embodiments, the all or a portion of the prepared master batch can be set aside (or stored) and utilized at a later time to form a reinforced polymer composition having a desired weight ratio of reinforcing agent to polymer; or alternatively, all of the master batch can be can be utilized shortly after it preparation to form a reinforced polymer composition having a desired weight ratio of reinforcing agent to polymer.

In an aspect, a process of producing a reinforced poly(arylene sulfide) composition can comprise 1) contacting a) a first mixture comprising i) a first poly(arylene sulfide) and ii) a reinforcing agent and b) a second poly(arylene sulfide) to form a second mixture, and 2) melt processing the second mixture. In another aspect, a process of producing a reinforced poly(arylene sulfide) composition can comprise 1) contacting a) a first mixture comprising, or consisting essentially of, i) a first poly(arylene sulfide) composition comprising, or consisting essentially of, a poly(arylene sulfide) and ii) a reinforcing agent composition comprising, or consisting essentially of, a reinforcing agent, and b) a second poly(arylene sulfide) composition comprising, or consisting essentially of, a poly(arylene sulfide) to form a second mixture, and 2) melt processing the second mixture. Generally, the poly(arylene sulfide) (general, first, second, or other), the poly(arylene sulfide) composition (general, first, second, or other), the mixture (general, first, second, or other), the reinforcing agent, or reinforcing agent composition are independent elements of any process in which they appear. A particular process to produce a reinforced poly(arylene sulfide) can be described utilizing any aspect or embodiment of the poly(arylene sulfide) described herein, any aspect or embodiment of the poly(arylene sulfide) composition described herein, any aspect or embodiment of the first mixture described herein, any aspect or embodiment of the second mixture described herein, any aspect or embodiment of the reinforcing agent described herein, and/or any aspect or embodiment of the reinforcing agent composition described herein. Additional process features are independently described herein and any aspect or embodiment of these independent features can be utilized to further describe any applicable process to produce the reinforced poly(arylene sulfide) composition described herein.

In any embodiment utilizing more than one poly(arylene sulfide) (general, first, second, or other), or poly(arylene sulfide) composition (general, first, second, or other), or poly(arylene sulfide), the poly(arylene sulfide)s or the poly(arylene sulfide)s of the poly(arylene sulfide) compositions can be the same; or alternatively, the poly(arylene sulfide)s can be different. In some embodiments, one or more of the poly(arylene sulfide)s (general, first, second, or other), or poly(arylene sulfide), or the poly(arylene sulfide)s of the poly(arylene sulfide) compositions (general, first, second, or other), or poly(arylene sulfide) can be, comprise, or consist essentially of, a poly(phenylene sulfide). Additionally, the form of the poly(arylene sulfide) (e.g., melt processed or non-melt processed, and/or cured or uncured, among other forms) utilized in the polymer compositions can be the same; or alternatively, can be different.

In an non-limiting embodiment utilizing a first poly(arylene sulfide) and a second poly(arylene sulfide), the first poly(arylene sulfide), the second poly(arylene sulfide), or the first poly(arylene sulfide) and the second poly(arylene sulfide) composition can be, comprise, or consist essentially of, a poly(phenylene sulfide); or alternatively, the first poly(arylene sulfide) and the second poly(arylene sulfide) can be, comprise, or consist essentially of, a poly(phenylene sulfide). In some non-limiting embodiments utilizing a first poly(arylene sulfide) composition and a second poly(arylene sulfide) composition, the first poly(arylene sulfide) of the first poly(arylene sulfide) composition, the second poly(arylene sulfide) of the second poly(arylene sulfide) composition, or the first poly(arylene sulfide) of the first poly(arylene sulfide) composition and the second poly(arylene sulfide) of the second poly(arylene sulfide) composition can be, comprise, or consist essentially of, a poly(phenylene sulfide); or alternatively, the first poly(arylene sulfide) of the first poly(arylene sulfide) composition and the second poly(arylene sulfide) of the second poly(arylene sulfide) composition can be, comprise, or consist essentially of, a poly(phenylene sulfide). In other non-limiting embodiment utilizing a first poly(arylene sulfide) composition and a second poly(arylene sulfide) composition, the first poly(arylene sulfide) composition, the second poly(arylene sulfide) composition, or the first poly(arylene sulfide) composition and the second poly(arylene sulfide) composition can comprise, or consist essentially of, a poly(phenylene sulfide); or alternatively, the first poly(arylene sulfide) composition and the second poly(arylene sulfide) composition can comprise, or consist essentially of, a poly(phenylene sulfide).

In an embodiment, the first poly(arylene sulfide) composition and/or second poly(arylene sulfide) composition can be any poly(arylene sulfide) composition devoid (or essentially devoid) of a reinforcing agent described herein. In some non-limiting embodiments, any first poly(arylene sulfide) composition comprising a first poly(arylene sulfide) can include a liquid medium; or alternatively, any first poly(arylene sulfide) comprising a first poly(arylene sulfide) can be essentially devoid of a liquid medium. In other non-limiting embodiments, any second poly(arylene sulfide) composition comprising a second poly(arylene sulfide) can include a liquid medium; or alternatively, any second poly(arylene sulfide) comprising a second poly(arylene sulfide) can be essentially devoid of a liquid medium. In yet other non-limiting embodiments, any first poly(arylene sulfide) composition comprising a first poly(arylene sulfide) and any second poly(arylene sulfide) composition comprising a second poly(arylene sulfide) can include a liquid medium; or alternatively, any first poly(arylene sulfide) composition comprising a first poly(arylene sulfide) and any second poly(arylene sulfide) composition comprising a second poly(arylene sulfide) can be essentially devoid of a liquid medium. Liquid mediums are described herein and can be utilized without limitation to further described a process of producing a reinforced poly(arylene sulfide) composition.

Generally, the reinforcing agent composition can be any reinforcing agent composition described herein. In a non-limiting embodiment, the reinforcing agent can be any reinforcing agent composition including a liquid medium described herein; or alternatively, any reinforcing agent composition essentially devoid of (or devoid of) a liquid medium described herein. In other non-limiting embodiments, the reinforcing agent can be any reinforcing agent composition including a dispersant described herein; or alternatively, any reinforcing agent composition essentially devoid of (or devoid of) a dispersant described herein.

When the first mixture (either through the first poly(arylene sulfide) composition and/or the reinforcing agent composition) includes a liquid medium the process of producing the reinforced poly(arylene sulfide) composition can include a step(s) for removing a portion of the liquid medium prior to contacting the first mixture with the second poly(arylene sulfide) (or poly(arylene sulfide) composition); alternatively, removing essentially all of the liquid medium prior to contacting the first mixture with the second poly(arylene sulfide) (or poly(arylene sulfide) composition). When the second mixture (either through the first poly(arylene sulfide) composition, the reinforcing agent composition, and/or the second poly(arylene sulfide composition) includes a liquid medium the process of producing the reinforced poly(arylene sulfide) composition can include a step(s) for removing the liquid medium prior to melt processing the second mixture. Steps for removing liquid medium from a composition are described herein and any aspect or embodiment of these steps can be utilized to further describe the process of producing reinforced polymer composition.

In an embodiment, the first poly(arylene sulfide) (or the first poly(arylene sulfide) composition) can be melt processed prior to contact with the reinforcing agent; or alternatively, can be non-melt processed prior to contact with the reinforcing agent. In some embodiments, the first mixture comprising, or consisting essentially of, the first poly(arylene sulfide) (or the first poly(arylene sulfide) and the reinforcing agent (or reinforcing agent composition) can be can be melt processed prior to contact with the second poly(arylene sulfide (or polyarylene sulfide composition); or alternatively, can be non-melt processed prior to contact with the second poly(arylene sulfide (or polyarylene sulfide composition). In other embodiments, the second poly(arylene sulfide) (or the second poly(arylene sulfide) composition) can be melt processed prior to contact with the first mixture (which can be melt processed or non-melt processed); or alternatively, can be non-melt processed prior to contact with the first mixture (which can be melt processed or non-melt processed).

In an embodiment, any poly(arylene sulfide) composition (general, first, second, or other) comprising a poly(arylene sulfide) (general, first, second, or other) and/or mixture (general, first, second, or other) can further comprise one or more additives. In an embodiment, a mixture formed by contacting (or alternatively, comprising) a poly(arylene sulfide) composition comprising a poly(arylene sulfide) and a reinforcing agent can further comprise one or more additives. In another embodiment, a process of producing a reinforced poly(arylene sulfide) composition can be a process wherein one or more of the first mixture, the second mixture, the first poly(arylene sulfide) composition, the second poly(arylene sulfide) composition further comprises one or more additives; alternatively, either the first mixture or the second mixture further comprises one or more additives; alternatively, both the first mixture and the second mixture further comprise one or more additives; alternatively, either the first poly(arylene sulfide) composition or the second poly(arylene sulfide) composition further comprises one or more additives; or alternatively, both the first poly(arylene sulfide) composition and the second poly(arylene sulfide) composition further comprise one or more additives. Additives (e.g., fire retardants, stabilizers, ultraviolet absorbers, lubricants, pigments, and/or fillers) are independently described herein and can be utilized without limitation to further described any process of producing a reinforced poly(arylene sulfide) composition described herein.

In an embodiment of a masterbatch process for producing a reinforced poly(arylene sulfide) composition, the first (polyarylene sulfide) (or the first poly(arylene sulfide) of the first poly(arylene sulfide) composition) and the reinforcing agent (or the reinforcing agent of the reinforcing agent composition) can be contacted at any reinforcing agent to poly(arylene sulfide) weight ratio disclosed herein that is higher than the final reinforcing agent to poly(arylene sulfide) weight ratio. Reinforcing agent to poly(arylene sulfide) weight ratios are disclosed herein and can be utilized without limitation to further describe the reinforcing agent to poly(arylene sulfide) weight ratio for the first mixture and the reinforcing agent to poly(arylene sulfide) weight ratio of the second mixture.

In an embodiment of a masterbatch process for producing a reinforced poly(arylene sulfide) composition, the first mixture and the second poly(arylene sulfide) (or the second poly(arylene sulfide) of the second polyarylene sulfide composition) can be contact at any poly(arylene sulfide) of the first mixture to second poly(arylene sulfide) (or second poly(arylene sulfide of the second poly(arylene sulfide composition) weight ratio that produces a second mixture having a desired reinforcing agent to poly(arylene sulfide) weight ratio. In some embodiments, the minimum weight ratio of the second poly(arylene sulfide) (or the second polyarylene sulfide of the second poly(arylene sulfide) composition) to the first poly(arylene sulfide) (or first poly(arylene sulfide of the first poly(arylene sulfide) composition, or first mixture) can be 1:1; alternatively, 2:1; alternatively, 3:1; or alternatively, 5:1. In other embodiments, the maximum weight ratio of the second poly(arylene sulfide) (or the second polyarylene sulfide of the second poly(arylene sulfide) composition) to the first poly(arylene sulfide) (or first poly(arylene sulfide of the first poly(arylene sulfide) composition, or first mixture) can be 50:1; alternatively, 40:1; alternatively, 30:1; alternatively, 20:1; or alternatively, 10:1. In other embodiments, the weight ratio of the second poly(arylene sulfide) (or the second polyarylene sulfide of the second poly(arylene sulfide) composition) to the first poly(arylene sulfide) (or first poly(arylene sulfide of the first poly(arylene sulfide) composition, can range from any minimum weight ratio of the second poly(arylene sulfide) (or the second polyarylene sulfide of the second poly(arylene sulfide) composition) to the first poly(arylene sulfide) (or first poly(arylene sulfide of the first poly(arylene sulfide) composition described herein to any maximum weight ratio of the second poly(arylene sulfide) (or the second polyarylene sulfide of the second poly(arylene sulfide) composition) to the first poly(arylene sulfide) (or first poly(arylene sulfide of the first poly(arylene sulfide) composition described herein. For example, in some non-limiting embodiments, the weight ratio of the second poly(arylene sulfide) (or the second polyarylene sulfide of the second poly(arylene sulfide) composition) to the first poly(arylene sulfide) (or first poly(arylene sulfide of the first poly(arylene sulfide) composition can range from 1:1 to 50:1; or alternatively, 1:1 to 20:1; alternatively, from 2:1 to 40:1; alternatively, from 2:1 to 20:1; alternatively, from 3:1 to 30:1; or alternatively 5:1 to 20:1. Other ranges of the weight ratio of the second poly(arylene sulfide) (or the second polyarylene sulfide of the second poly(arylene sulfide) composition) to the first poly(arylene sulfide) (or first poly(arylene sulfide of the first poly(arylene sulfide) composition are readily apparent from the present disclosure.

In an aspect the reinforced polymer composition described herein (e.g., reinforced poly(arylene sulfide) compositions described herein), mixtures (general, first, second, or other) described herein, and/or polymer compositions (general, first, second or other) described herein can further comprise one or more additives. In an embodiment, the additive(s) can be selected from the group consisting of fire retardants, stabilizers, ultraviolet absorbers, lubricants, pigments, and fillers. In some embodiments, any reinforced polymer composition described herein (e.g., reinforced poly(arylene sulfide) compositions described herein), mixtures (general, first, second, or other) described herein, and/or polymer compositions (general, first, second or other) described herein can further comprise a fire retardant; alternatively, an ultraviolet absorber; alternatively, a lubricant; alternatively, a pigment; or alternatively, filler.

In an embodiment, the fire retardant can be a phosphorus based fire retardant, a halogen based fire retardant, a boron based fire retardant, an antimony based fire retardant, an amide based fire retardant, or any combination thereof. In some embodiments, any composition described herein, mixture (general, first, second, or other) described herein, and/or polymer composition (first second or other) described herein can further comprise a phosphorus based fire retardant; alternatively, a halogen based fire retardant; alternatively, a boron based fire retardant; alternatively, an antimony based fire retardant; or alternatively, an amide based fire retardant. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g. benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g. benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds. In an embodiment, ultraviolet absorbers which can be utilized include, but are not limited to, oxalic acid diamide compounds or sterically hindered amine compounds. In an embodiment, lubricants which can be utilized include, but are not limited to, polyethylene waxes, polypropylene waxes, and paraffins. In an embodiment, pigments which can be utilized include, but are not limited to, titanium dioxide, zinc sulfide, or zinc oxide.

In an embodiment, fillers which can be utilized include, but are not limited to, a mineral filler, an inorganic filler, or an organic filler. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos, wollastonite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, or any combination thereof; alternatively, carbon fibers; or alternatively, carbon black. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an aspect, the reinforced polymer composition (e.g., reinforced poly(arylene sulfide) composition or poly(phenylene sulfide composition, among others) can be cured through an oxidative heat treatment. In an embodiment, the reinforced polymer composition can be heated to a temperature above 150° C. in the presence of free oxygen-containing gas. Aspects and embodiment for curing poly(arylene sulfide)s (or poly(phenylene sulfide)s) are described herein and these aspects and embodiments can be utilized without limitation to describe the curing of the reinforced polymer composition. Agents that can affect curing, such as peroxides, accelerants, and/or inhibitors, can be incorporated into the reinforced polymeric material. The cured reinforced polymeric material can be characterized generally as exhibiting high thermal stability and good chemical resistance.

In an aspect, a melt processed reinforced polymer composition comprising (or consisting essentially of) a reinforcing agent (any described herein) and a polymer (any described herein) can have a desirable property. In an embodiment, the weight ratio of the reinforcing agent to the polymer in the reinforced polymer composition comprising (or consisting essentially of) a reinforcing agent (any described herein) and a polymer (any described herein) can be any weight ratio which provides the desirable property. Weight ratios of the reinforcing agent to the polymer in the reinforced polymer composition comprising (or consisting essentially of) a reinforcing agent (any described herein) and a polymer (any described herein) are disclosed herein and can be utilized without limitation to describe a melt processed reinforced polymer composition comprising (or consisting essentially of) a reinforcing agent (any described herein) and a polymer (any described herein) having any desirable property described herein.

In an aspect, the melt processed reinforced polymer composition comprising (or consisting essentially of) a reinforcing agent (any described herein) and a polymer (any described herein) can have a particular surface electrical resistivity; alternatively, a particular volume electrical resistivity. In an embodiment, the surface electrical resistivity (and/or the volume electrical resistivity) of melt processed reinforced polymer composition comprising (or consisting essentially of) a reinforcing agent (any described herein) and a polymer (any described herein) can be described as insulating; alternatively, static dissipative or conductive; alternatively, static dissipative; or alternatively, conductive.

In an embodiments, the surface electrical resistivity of a melt processed reinforced polymer composition comprising (or consisting essentially of) a reinforcing agent (any described herein) and a polymer (any described herein) can be described as have a particular measured electrical resistivity. In some embodiments, the minimum surface electrical resistivity of the melt processed reinforced polymer composition comprising, or consisting essentially, of the reinforcing agent and the polymer can be 1×10³ ohms per square; alternatively, 1×10⁴ ohms per square; alternatively, 1×10⁵ ohms per square; alternatively, 1×10⁶ ohms per square; alternatively, 1×10⁷ ohms per square; alternatively, 1×10⁸ ohms per square; alternatively, 1×10⁹ ohms per square; alternatively, 1×10¹⁰ ohms per square; alternatively, 1×10¹¹ ohms per square; alternatively, 1×10¹² ohms per square; or alternatively, 1×10¹³ ohms per square. In other embodiments, the maximum surface electrical resistivity of the melt processed reinforced polymer composition comprising, or consisting essentially, of the reinforcing agent and the polymer can be 1×10¹⁵ ohms per square; alternatively, 1×10¹⁴ ohms per square; alternatively, 1×10¹³ ohms per square; alternatively, 1×10¹² ohms per square; alternatively, 1×10¹¹ ohms per square; alternatively, 1×10¹⁰ ohms per square; alternatively, 1×10⁹ ohms per square; alternatively, 1×10⁸ ohms per square; alternatively, 1×10⁷ ohms per square; alternatively, 1×10⁶ ohms per square; alternatively, 1×10⁵ ohms per square; or alternatively, alternatively, 1×10⁴ ohms per square. In yet other embodiments, the surface electrical resistivity of the melt processed reinforced polymer composition comprising, or consisting essentially, of the reinforcing agent and the polymer can range from any minimum surface electrical resistivity disclosed herein to any maximum surface electrical resistivity disclosed herein. For example, in some non-limiting embodiments, the surface electrical resistivity of the melt processed reinforced polymer composition comprising, or consisting essentially, of the reinforcing agent and the polymer can range from 1×10³ ohms per square to 1×10¹⁵ ohms per square; alternatively, 1×10³ ohms per square to 1×10¹² ohms per square; alternatively, 1×10⁴ ohms per square to 1×10¹² ohms per square; alternatively, 1×10⁴ ohms per square to 1×10¹¹ ohms per square; alternatively, 1×10³ ohms per square to 1×10⁶ ohms per square; alternatively, 1×10⁴ ohms per square to 1×10⁶ ohms per square; alternatively, 1×10⁴ ohms per square to 1×10⁵ ohms per square; alternatively, 1×10⁶ ohms per square to 1×10¹² ohms per square; or alternatively, alternatively, 1×10⁴ ohms per square to 1×10¹¹ ohms per square. Other ranges for the surface electrical resistivity of the melt processed reinforced polymer composition comprising, or consisting essentially, of the reinforcing agent and the polymer are readily apparent from the present disclosure.

In an embodiments, the volume electrical resistivity of a melt processed reinforced polymer composition comprising (or consisting essentially of) a reinforcing agent (any described herein) and a polymer (any described herein) can be described as have a particular measured electrical resistivity. In some embodiments, the minimum volume electrical resistivity of the melt processed reinforced polymer composition comprising, or consisting essentially, of the reinforcing agent and the polymer can be 1×10² ohms per cm; alternatively, 1×10³ ohms per cm; alternatively, 1×10⁴ ohms per cm; alternatively, 1×10⁵ ohms per cm; alternatively, 1×10⁶ ohms per cm; alternatively, 1×10⁷ ohms per cm; alternatively, 1×10⁸ ohms per cm; alternatively, 1×10⁹ ohms per cm; alternatively, 1×10¹⁰ ohms per cm; alternatively, 1×10¹¹ ohms per cm; or alternatively, 1×10¹² ohms per cm. In other embodiments, the maximum volume electrical resistivity of the melt processed reinforced polymer composition comprising, or consisting essentially, of the reinforcing agent and the polymer can be 1×10¹⁴ ohms per cm; alternatively, 1×10¹³ ohms per cm; alternatively, 1×10¹² ohms per cm; alternatively, 1×10¹¹ ohms per cm; alternatively, 1×10¹⁰ ohms per cm; alternatively, 1×10⁹ ohms per cm; alternatively, 1×10⁸ ohms per cm; alternatively, 1×10⁷ ohms per cm; alternatively, 1×10⁶ ohms per cm; alternatively, 1×10⁵ ohms per cm; alternatively, 1×10⁴ ohms per cm; or alternatively, alternatively, 1×10³ ohms per cm. In yet other embodiments, the volume electrical resistivity of the melt processed reinforced polymer composition comprising, or consisting essentially, of the reinforcing agent and the polymer can range from any minimum surface electrical resistivity disclosed herein to any maximum surface electrical resistivity disclosed herein. For example, in some non-limiting embodiments, the volume electrical resistivity of the melt processed reinforced polymer composition comprising, or consisting essentially, of the reinforcing agent and the polymer can range from 1×10² ohms per cm to 1×10¹⁴ ohms per cm; alternatively, 1×10² ohms per cm to 1×10″ ohms per cm; alternatively, 1×10³ ohms per cm to 1×10¹¹ ohms per cm; alternatively, 1×10³ ohms per cm to 1×10¹⁰ ohms per cm; alternatively, 1×10² ohms per cm to 1×10⁵ ohms per cm; alternatively, 1×10³ ohms per cm to 1×10⁵ ohms per cm; alternatively, 1×10³ ohms per cm to 1×10⁴ ohms per cm; alternatively, 1×10⁵ ohms per cm to 1×10¹¹ ohms per cm; or alternatively, alternatively, 1×10³ ohms per cm to 1×10¹⁰ ohms per cm. Other ranges for the volume electrical resistivity of the melt processed reinforced polymer composition comprising, or consisting essentially, of the reinforcing agent and the polymer are readily apparent from the present disclosure.

In an aspect, the addition of a reinforcing agent (any described herein) to a polymer (any described herein) can have a beneficial impact on the crystallization behavior of a reinforced polymer composition comprising (or consisting essentially of) a reinforcing agent (any described herein) and a polymer (any described herein). The improved crystallization behavior or the reinforced polymer composition can result in improved efficiencies in molding applications. For example, components formed in the mold when using a reinforced polymer composition described herein can be removed from the molds more quickly and can provide reduced cycle times and/or an increased efficiency in producing molded articles.

Generally, the crystallization behavior of a composition (e.g., reinforced polymer composition) can be described utilizing one or more of a glass transition temperature (T_{g}), a crystallization temperature from the glassy state (T_{cc}—also referred herein as cold crystallization temperature), a melt crystallization temperature (T_{mc}), and a melt temperature (Tₘ). T_{g}, Tₘ, T_{mc}, and T_{cc} can be determined using differential scanning calorimetry. T_{g}, T_{cc}, and Tₘ can be determined using differential scanning calorimetry by heating the composition (e.g., reinforced polymer composition) starting at a temperature below its glass transition through the glass transition to obtain the glass transition temperature (T_{g}), through its cold crystallization transition to obtain the cold crystallization temperature (T_{cc}), and through its melting transition to obtain the its melting temperature (Tₘ). T_{mc} can be determined using differential scanning calorimetry by cooling the composition (e.g., reinforced polymer composition) from a temperature above its melting transition through its melt crystallization transition to obtain the melt crystallization temperature (T_{mc}). The impact that the reinforcing agent can have on the crystallization behavior of the a reinforced polymer composition comprising (or consisting essentially of) a reinforcing agent (any described herein) and a polymer (any described herein) can be made by comparing the crystallization behavior of the reinforced polymer composition to the crystallization behavior of a similar polymer composition devoid of (or essentially devoid of) the reinforcing agent. In situations where the method of polymer production, isolation, and/or post production (and/or isolation) treatment can impact the crystallization behavior of the polymer composition and/or the reinforced polymer composition, the comparison between the reinforced polymer composition and the similar polymer composition devoid of (or essentially devoid of) the reinforcing agent should be made between a reinforced polymer composition and a polymer composition devoid of (or essentially devoid of) reinforcing agent which has utilized similar production methods, isolation method, and/or post production (and/or isolation) treatments.

Generally, the addition of a reinforcing agent to a polymer to form a reinforced polymer composition (using any method described herein) does not appear to significantly impact the glass transition temperature (T_{g}) or melt temperature (Tₘ) of the reinforced polymer composition when compared to a similar polymer composition devoid of (or essentially devoid of) the reinforcing agent. However, the addition of a reinforcing agent to a polymer to form a reinforced polymer composition (using any method described herein) can have an impact on the cold crystallization temperature (T_{cc}) and/or melt crystallization temperature (T_{mc}) when compared to a similar polymer composition devoid of (or essentially devoid of) the reinforcing agent.

In an aspect, the addition of an reinforcing agent to a polymer to form a reinforced polymer composition (using any method described herein) can provide a reduction in the cold crystallization temperature, an increase in the melt crystallization temperature, an increase in the crystallization temperature window, an increase in the crystallization window ratio, or any combination thereof when compared to a similar polymer composition devoid of (or essentially devoid of) the reinforcing agent. In some non-limiting embodiments, the addition of an reinforcing agent to a polymer to form a reinforced polymer composition (using any method described herein) can provide a reduction in the cold crystallization temperature, an increase in the melt crystallization temperature, an increase in the, or any combination thereof when compared to a similar polymer composition devoid of (or essentially devoid of) the reinforcing agent; alternatively, an increase in the melt crystallization temperature, an increase in the crystallization temperature window, or any combination thereof when compared to a similar polymer composition devoid of (or essentially devoid of) the reinforcing agent. In further embodiments, the addition of an reinforcing agent to a polymer to form a reinforced polymer composition (using any method described herein) can provide a reduction in the cold crystallization temperature when compared to a similar polymer composition devoid of (or essentially devoid of) the reinforcing agent; alternatively, an increase in the melt crystallization temperature when compared to a similar polymer composition devoid of (or essentially devoid of) the reinforcing agent; alternatively, an increase in the crystallization temperature window when compared to a similar polymer composition devoid of (or essentially devoid of) the reinforcing agent; or alternatively, an increase in the crystallization window ratio when compared to a similar polymer composition devoid of (or essentially devoid of) the reinforcing agent.

In an embodiment the reinforced polymer composition (any disclosed herein) can have a cold crystallization temperature, T_{cc}, at least 2° C., at least 3° C., at least 4° C., at least 5° C., or at least 6° C. less than a similar polymer composition devoid of (or essentially devoid of) the reinforcing agent. In some embodiments, the reinforced polymer composition (any disclosed herein) can have a cold crystallization temperature, T_{cc}, at least 2%, 3%, 4%, or 5% less than the cold crystallization temperature of a similar polymer composition devoid of (or essentially devoid of) the reinforcing agent.

In an embodiment, the reinforced polymer composition (any disclosed herein) can have a melt crystallization temperature, T_{mc}, at least 5° C., at least 7.5° C., at least 10° C., at least 12.5° C., at least 15° C., at least 20° C. greater than a similar polymer composition devoid of (or essentially devoid of) the reinforcing agent. In some embodiments, the reinforced polymer composition (any disclosed herein) can have a melt crystallization temperature, T_{mc}, at least 4%, 6%, 8%, 10%, or 12% greater than the melt crystallization temperature of a similar polymer composition devoid of (or essentially devoid of) the reinforcing agent.

In an embodiment, the reinforced polymer composition (any disclosed herein) can have a crystallization temperature window (given by the equation T_{mc}−T_{cc}) at least 5° C., at least 10° C., at least 15° C., at least 20° C., at least 25° C., at least 30° C. greater than a similar polymer composition devoid of (or essentially devoid of) the reinforcing agent. In some embodiments, the reinforced polymer composition (any disclosed herein) can have a crystallization temperature window at least 10%, 15%, 20%, 25%, 30%, or 35% greater than the crystallization temperature window of a similar polymer composition devoid of (or essentially devoid of) the reinforcing agent.

Crystallization window ratio, CWR, is a measure of the proportion of the theoretical maximum crystallization temperature window, Tₘ−T_{g}, over which the polymer composition's actual crystallization temperature window, T_{mc}−T_{cc}, spans. The crystallization window ratio can be calculated using the Equation 1.

$$CWR = \frac{{T}_{mc} - {T}_{cc}}{{T}_{m} - {T}_{g}} \qquad Equation 1$$

In an embodiment, the reinforced polymer composition (any disclosed herein) can have a crystallization window ratio can be at least 0.05, at least 0.075, at least 0.1, at least 0.125, or at least 0.15 greater than a similar polymer composition devoid of (or essentially devoid of) the reinforcing agent. In some embodiments, the reinforced polymer composition (any disclosed herein) can have a crystallization window ratio that is at least 5%, at least 10%, at least 15%, at least 20%, at least 30%, or at least 40% greater than the crystallization window ratio of a similar polymer composition devoid of (or essentially devoid of) the reinforcing agent.

In an aspect, a reinforced polymer composition (e.g., a reinforced poly(arylene sulfide) composition or poly(phenylene sulfide) composition) described herein which has been cured can have improved properties when compared to similar polymer devoid of (or essentially devoid of) the reinforcing agent. In an embodiment, a reinforced poly(arylene sulfide) composition (or poly(phenylene sulfide) composition) which has been cured for one hour can have a flow rate 5%, 10%, 15%, 20%, or 25% less than a similar poly(arylene sulfide) composition (or poly(phenylene sulfide) composition that is devoid of (or essentially devoid of) the reinforcing agent. In another embodiment, a reinforced poly(arylene sulfide) composition (or poly(phenylene sulfide) composition) which has been cured for two hours can have a flow rate 10%, 20%, 30%, 35%, or 40% less than a similar poly(arylene sulfide) composition (or poly(phenylene sulfide) composition that is devoid of (or essentially devoid of) the reinforcing agent.

Generally, the melt processing can be any process, step(s) which can render the reinforced polymer composition in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The reinforced polymer composition (e.g., a reinforced poly(arylene sulfide) composition or poly(phenylene sulfide) composition) described herein can be formed or molded into a variety of components or products for a diverse range of applications and industries. For example, the reinforced polymer composition described herein can be heated and molded into desired shapes and composites in a variety of processes, equipment, and operations. For example, the reinforced polymer compositions can be subjected to heat, compounding, injection molding, blow molding, precision molding, film-blowing, extrusion, and so forth. Additionally, additives, such as those mentioned herein, can be blended or compounded within the reinforced polymer composition. The output of such techniques can include, for example, polymer intermediates or composites including the reinforced polymer composition, and manufactured product components or pieces formed from the reinforced polymer composition, and so on. These manufactured components can be sold or delivered directly to a user. On the other hand, the components can be further processed or assembled in end products, for example, in the industrial, consumer, automotive, and electrical/electronic industries.

Many diversified applications and uses can benefit from the advantageous properties of the reinforced polymer composition described herein. For example, the reinforced polymer compositions can exhibit rapid crystallization and/or exhibit dissipation of electrostatic charges due to the increased electrical conductivity. Thus, an assortment of components or products including the reinforced polymer composition described herein can be manufactured or assembled using different processes and operations. A wide range of appliance products or components incorporating the reinforced polymer compositions described herein can include, electric blanket thermostats, fry pan handles, hair dryer grills, coffee warmer rings, curling iron insulators, steam iron valves, toaster switches, clothes dryer switches, clothes washer pumps, dishwasher pumps, non-stick cookware coatings, and microwave oven turntables, to name a few. Exemplary business appliance products using the reinforced polymer compositions described herein can include printer paper guards, copier gears, fax machine heads, and medical/scientific instrument components. Household and automotive lighting products constructed using the reinforced polymer compositions described herein can include reflectors, reflector housings, bulb housings, socket bases, and ballast components.

The reinforced polymer compositions described herein can be utilized in applications involving automotive brake systems which include anti-lock brake (ABS) motor components, electric brakes, ABS brake pistons, booster pistons, and valve bodies. Automotive coolant system applications utilizing the reinforced polymer compositions described herein can include heater core tanks, thermostat housings, water pump impellers, extension tubes, valve components, water inlet/outlet connections. Further, automotive electrical system components incorporating the reinforced polymer compositions described herein can include, for example, alternator components, switches, connectors, ignition components, motor brush cards, and sensors. Fuel system applications include fuel flow sensors, fuel pump components, throttle bodies/deactivator, fuel line connectors, fuel rails, and fuel injector bobbins, to name a few. Also, power train/transmission components which can utilize the reinforced polymer composition described herein include lock-up collars, servo pistons and covers, engine gasket carriers, seal housings, shift cams/forks, stators, and transmission pistons. Electrical and electronic applications utilizing the reinforced polymer compositions described herein can be found in a wide range of residential, commercial, and industrial uses, and can include, for example, applications in computer systems, instrumentation and control systems, power supply systems, and so on. More specific examples of components incorporating the reinforced polymer compositions described herein can include electrical connectors, terminal blocks, electrical relays/switches (e.g., relay contact bases), circuit breaker housings, and high temperature housings for electrical components, electronics packaging (e.g., capacitor encapsulation housings), computer memory module sockets, chip carrier sockets, hard disk drive components, to name a few. The reinforced polymer compositions described herein can be incorporated in a variety of components and products in commercial and industrial applications. For example, heating, ventilation, and air conditioning (HVAC) applications utilizing the reinforced polymer composition described herein can include compressor mufflers, flue collectors, secondary heat exchanger headers, fuel oil pumps, hot water circulation components, power vent components, thermostat components, and so on. Other applications which can utilize the reinforced polymer composition described herein can include centrifugal pump impellers, chemical pump vanes, corrosion resistant coating, and filter bags for flue gas in coal burning plants.

Various aspects and embodiments described herein refer to substituents or substituent groups. In an embodiment, each substituent of any aspect or embodiment calling for a substituent independently can be a halide, a hydrocarbyl group, or a hydrocarboxy group; alternatively, a halide or a hydrocarbyl group; alternatively, a halide or a hydrocarboxy group; alternatively, a hydrocarbyl group or a hydrocarboxy group; alternatively, a halide; alternatively, a hydrocarbyl group; or alternatively, a hydrocarboxy group. In some embodiments, each substituent of any aspect or embodiment calling for a substituent independently can be a halide, a C₁ to C₁₀ hydrocarbyl group, or a C₁ to C₁₀ hydrocarboxy group; alternatively, a halide or a C₁ to C₁₀ hydrocarbyl group; alternatively, a halide or a C₁ to C₁₀ hydrocarboxy group; alternatively, a C₁ to C₁₀ hydrocarbyl group or a C₁ to C₁₀ hydrocarboxy group; alternatively, a halide; alternatively, a C₁ to C₁₀ hydrocarbyl group; or alternatively, a C₁ to C₁₀ hydrocarboxy group. In other embodiments, each substituent of any aspect or embodiment calling for a substituent independently can be a halide, a C₁ to C₅ hydrocarbyl group, or a C₁ to C₅ hydrocarboxy group; alternatively, a halide or a C₁ to C₅ hydrocarbyl group; alternatively, a halide or a C₁ to C₅ hydrocarboxy group; alternatively, a C₁ to C₅ hydrocarbyl group or a C₁ to C₅ hydrocarboxy group; alternatively, a halide; alternatively, a C₁ to C₅ hydrocarbyl group; or alternatively, a C₁ to C₅ hydrocarboxy group.

In an embodiment, any halide substituent of any aspect or embodiment calling for a substituent can be a fluoride, chloride, bromide, or iodide; alternatively, a fluoride or chloride. In some embodiments, any halide substituent of any aspect or embodiment calling for a substituent can be a fluoride; alternatively, a chloride; alternatively, a bromide; or alternatively, an iodide.

In an embodiment, any hydrocarbyl substituent of any aspect or embodiment calling for a substituent can be an alkyl group, an aryl group, or an aralkyl group; alternatively, an alkyl group; alternatively, an aryl group; or alternatively, an aralkyl group. In an embodiment, any alkyl substituent of any aspect or embodiment calling for a substituent can be a methyl group, an ethyl group, an n-propyl group, an isopropyl group, an n-butyl group, a sec-butyl group, an isobutyl group, a tert-butyl group, an n-pentyl group, a 2-pentyl group, a 3-pentyl group, a 2-methyl-1-butyl group, a tert-pentyl group, a 3-methyl-1-butyl group, a 3-methyl-2-butyl group, or a neo-pentyl group; alternatively, a methyl group, an ethyl group, an isopropyl group, a tert-butyl group, or a neo-pentyl group; alternatively, a methyl group; alternatively, an ethyl group; alternatively, an isopropyl group; alternatively, a tert-butyl group; or alternatively, a neo-pentyl group. In an embodiment, any aryl substituent of any aspect or embodiment calling for a substituent can be phenyl group, a tolyl group, a xylyl group, or a 2,4,6-trimethylphenyl group; alternatively, a phenyl group; alternatively, a tolyl group; alternatively, a xylyl group; or alternatively, a 2,4,6-trimethylphenyl group. In an embodiment, any aralkyl substituent of any aspect or embodiment calling for a substituent can be benzyl group or an ethylphenyl group (2-phenyleth-1-yl or 1-phenyleth-1-yl); alternatively, a benzyl group; alternatively, an ethylphenyl group; alternatively, a 2-phenyleth-1-yl group; or alternatively, a 1-phenyleth-1-yl group.

In an embodiment, any hydrocarboxy substituent of any aspect or embodiment calling for a substituent can be an alkoxy group, an aryloxy group, or an aralkoxy group; alternatively, an alkoxy group; alternatively, an aryloxy group, or an aralkoxy group. In an embodiment, any alkoxy substituent of any aspect or embodiment calling for a substituent can be a methoxy group, an ethoxy group, an n-propoxy group, an isopropoxy group, an n-butoxy group, a sec-butoxy group, an isobutoxy group, a tert-butoxy group, an n-pentoxy group, a 2-pentoxy group, a 3-pentoxy group, a 2-methyl-1-butoxy group, a tert-pentoxy group, a 3-methyl-1-butoxy group, a 3-methyl-2-butoxy group, or a neo-pentoxy group; alternatively, a methoxy group, an ethoxy group, an isopropoxy group, a tert-butoxy group, or a neo-pentoxy group; alternatively, a methoxy group; alternatively, an ethoxy group; alternatively, an isopropoxy group; alternatively, a tert-butoxy group; or alternatively, a neo-pentoxy group. In an embodiment, any aryloxy substituent of any aspect or embodiment calling for a substituent can be phenoxy group, a toloxy group, a xyloxy group, or a 2,4,6-trimethylphenoxy group; alternatively, a phenoxy group; alternatively, a toloxy group; alternatively, a xyloxy group; or alternatively, a 2,4,6-trimethylphenoxy group. In an embodiment, any aralkoxy substituent of any aspect or embodiment calling for a substituent can be benzoxy group.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### EXAMPLES

The following examples are set forth to provide a detailed description of how the methods claimed herein are evaluated, and are not intended to limit the scope of what the inventors regard as their invention.

Sodium hydrogen sulfide was utilized as a 59.749 wt. % sodium hydrogen sulfide solution in distilled water. Sodium hydroxide was obtained from Fischer Scientific as a 98.5 wt. % sodium hydroxide pellets and utilized as obtained. N-methyl-2-pyrrolidone was obtained from Fisher Scientific as lab grade N-methyl-2-pyrrolidone and utilized as obtained. Para-dichlorobenzene was obtained from Solutia as a 99.99 weight % para-dichlorobenzene and utilized as obtained. Fluorinated single-walled carbon nanotubes (F-SWNT) were obtained from NanoRidge Materials, Inc and utilized as obtained. Non-fluorinated single-walled carbon nanotubes (SWNT) were obtained from a commercial source and utilized as obtained. Nanosperse AQ was obtained NanoLab Inc. and utilized as obtained.

Glass transition temperatures (T_{g}), the crystallization temperatures from the glassy state (T_{cc}), melt temperatures (Tₘ), melt crystallization temperatures (T_{mc}) were determined using differential scanning calorimetry (DSC). Poly(phenylene) sulfides (containing reinforcing agents or devoid of reinforcing agents) were prepared for DSC by forming a film of the poly(phenylene sulfide) composition.

Poly(phenylene sulfide) composition films for DSC analysis were prepared using a platen press using the following process:
1) place 1 to 2 grams of the poly(phenylene sulfide) composition between 2 sheets of Kapton® release material;
2) press the poly(phenylene sulfide) composition to contact pressure at 325° F. for 2 minutes;
3) increase the platen press pressure to 5000 psi and hold for 1 to 2 minutes and then increase the platen press pressure to 15,000 psi for 1 minute;
4) release the platen press pressure;
5) remove the poly(phenylene sulfide) composition film; and
6) cool the film in a room temperature water bath.
   Unless specifically indicated otherwise, DSCs were performed by taking a 0.4-0.8 mg sample of the film and placing in the DSC pan. The sample was equilibrated at 0° C. for 10 minutes and then the sample heated at a rate of 20° C. per minute to 350° C. The temperature was equilibrated at 350° C. for 5 minutes and then the sample cooled at a rate of 20° C. per minute to 0° C. Glass transition temperatures (T_{g}), crystallization temperatures from the glassy state (T_{cc}), and melt temperatures (Tₘ) were obtained from the heating phase of the DSC while melt crystallization temperatures (T_{mc}) were obtain from the cooling phase of the DSC.

In the following examples, the rate at which the polymer composition flows through an orifice can be reported as a rate measured by one or more methods. Extrusion Rate (ER) is based upon ASTM D 1238-86, Procedure B-Automatically Timed Flow Rate Procedure, Condition 315/5.0 modified to 1) use an orifice having a 2.096±0.005 mm diameter and a 31.75±0.05 mm length, 2) use a 345 gram drive weight instead of a 5000 gram drive weight, 3) use a 5 minute preheat time, and 4) use a 315.6° C. test temperature. 1270 Extrusion Rate (1270ER) is based upon ASTM D 1238-86, Procedure B—Automatically Timed Flow Rate Procedure, Condition 315/5.0 modified to 1) use an orifice having a 2.096±0.005 mm diameter and a 31.75±0.05 mm length, 2) use a 1270 gram drive weight instead of a 5000 gram drive weight, 3) use a 5 minute preheat time, and 4) use a 315.6° C. test temperature. Melt Flow (MF) is based upon ASTM D 1238-86, Procedure B-Automatically Timed Flow Rate Procedure, Condition 315/5.0 modified to 3) use a 5 minute preheat time, and 4) use a 315.6° C. test temperature. Each of these methods reports the flow of the polymer composition in units of grams/10 minutes.

### Example 1

### Fluorinated Single-Walled Carbon Nanotube Reinforced Poly(Phenylene Sulfide)

A sample of poly(phenylene sulfide) was synthesized in the presence of fluorinated single-walled carbon nanotubes (F-SWNT). To a 1-liter titanium reactor was added 0.666 moles of NaSH (62.50 grams), 0.680 moles of NaOH (27.61 grams), and 1.665 moles of N-methyl-2-pyrrolidone (165.05 grams). The reactor was closed and the reactor stirrer operated at 175 revolutions per minute. The reactor was purged of air by charging the reactor with nitrogen to 50 psig and then depressurizing the reactor five times and then charging the reactor with nitrogen to 200 psig and the depressurizing five times. Water was then removed (also referred to as dehydration) from the reactor by heating the reactor to approximately 140° C. The dehydration line was then opened, a nitrogen flow rate of 32 cc/minute initiated into the reactor, and the reactor heated to approximately 200° C. over a period of 95 minutes. During this time 25 mL of liquid was collected. Gas chromatography of the collected liquid indicated that the collected liquid contained 96 weight % water and 4.0 weight % N-methyl-2-pyrrolidone.

Upon completion of the dehydration, the dehydration line was closed, the reactor was charged to 50 psig with nitrogen, and the nitrogen the nitrogen flow was discontinued. The reactor was then cooled to 50° C. The reactor head was then opened and the contents of a container containing 0.5 grams of fluorinated single walled nanotubes having 15 wt. % fluorine were poured into the reactor. The container was then rinsed with 0.25 moles of N-methyl-2-pyrrolidone (25 grams) and the rinse poured into the reactor. The reactor was closed and stirring initiated at 350 revolutions per minute. The contents of the reactor stirred for approximately 5 minutes under a small nitrogen purge while being heated. The nitrogen purge was discontinued and the heating of the reactor was then continued until the reactor attained 250° C. (approximately 25 minutes).

To a 0.3 liter charging vessel was added 0.666 moles of para-dichlorobenzene (98.0 grams) and 0.25 moles of N-methyl-2-pyrrolidone (25.0 grams). The charging vessel was then purged with nitrogen, closed, and placed in a heated bath (at approximately 100° C.) until it was to be charged to the reactor. When the reactor attained 250° C., the contents of the charging vessel were then pressured (nitrogen pressure) into the reactor. The charging vessel was rinsed with 0.5 moles of N-methyl-2-pyrrolidone (49.56 grams) and the rinse pressured (nitrogen pressure) into the reactor. Once the contents of the charging reactor was charged to the reactor, the reactor temperature was increased to 250° C. and was maintained at 250° C. for approximately four hours.

The reactor was then cooled to room temperature overnight. The reactor was then opened to reveal a semi-cake material with dark grey color. No particles were visible and a soupy appearance was observed near at the bottom of the material. The entire contents of the reactor was recovered from the reactor, washed with isopropyl alcohol, and filtered. The isopropyl alcohol extract was analyzed by gas chromatography. The gas chromatograph analysis of the recovered isopropyl alcohol extract indicated a 1.4 wt. % excess of para-dichlorobenzene. The recovered reinforced poly(phenylene sulfide) was washed with hot (90° C.) distilled water and filtered five times. The washed reinforced poly(phenylene sulfide) was then dried overnight in a vacuum oven operated at 100° C. at 12 inches of mercury (absolute). The reinforced poly(phenylene sulfide) weighed 67.3 grams and had an Extrusion Rate (ER) of 8.7 (1.75 g/120.8 sec.) Assuming no loss of fluorinated single-walled nanotubes, the reinforced poly(phenylene sulfide) contained 0.743 wt. % single-walled nanotubes.

A sample of the reinforced poly(phenylene sulfide), 10 grams, was placed in a container and covered with methanol and allowed to sit for 30 minutes. The contents of the container were then filtered and the reinforced poly(phenylene sulfide) rinsed with 5 L of distilled water. The recovered reinforced poly(phenylene sulfide), 500 mL of distilled water, and 5 grams of glacial acetic acid were placed in a 1 liter titanium reactor. The reactor was closed, purged 5 times with 50 psig of nitrogen, and then purged 5 times with 200 psig of nitrogen. The reactor was then left with a 20 psig nitrogen atmosphere. Stirring was initiated at approximately 125 revolutions per minute, the reactor heated to 235° C., and the mixture maintained at 235° C. for 30 minutes. The reactor was then allowed to cool to room temperature overnight.

The reactor was then opened and the entire contents of the reactor were recovered. The reactor contents were then filtered. The recovered acid-washed reinforced poly(phenylene sulfide) was washed with hot (90° C.) distilled water and filtered five times. The acid-washed reinforced poly(phenylene sulfide) was then dried overnight in a vacuum oven operated at 100° C. at 12 inches of mercury (absolute). The recovered acid-washed reinforced poly(phenylene sulfide) weighed 9.3 grams.

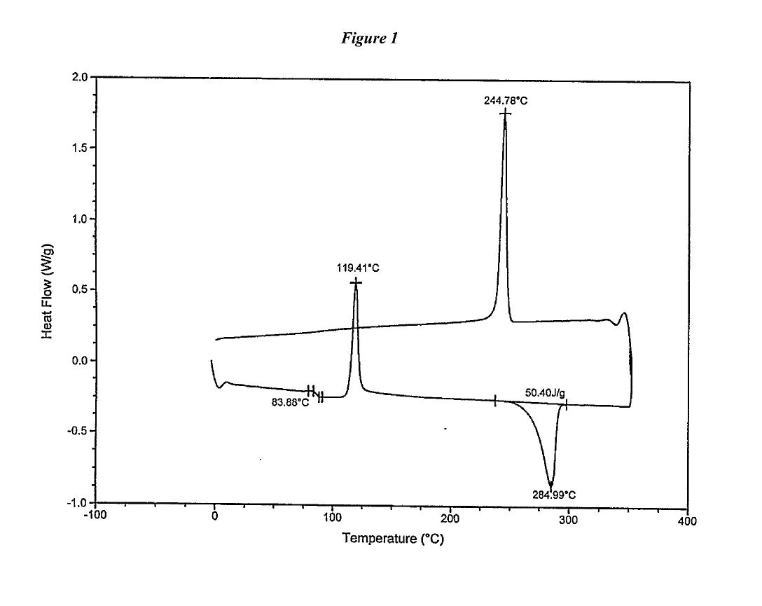

Films of the non-acid-washed poly(phenylene sulfide) and the acid-washed reinforced poly(phenylene sulfide) were molded and samples of the film were subjected to differential scanning calorimetry. Glass transition temperatures (T_{g}), crystallization temperatures from the glassy state (T_{cc}), melt temperatures (Tₘ), and melt crystallization temperatures (T_{mc}) for the two reinforced poly(phenylene sulfide) samples are provided in Table 1. FIG. 1 provides the DSC of the non-acid-washed reinforced poly(phenylene sulfide).

### Example 2

### Fluorinated Single-Walled Carbon Nanotube Reinforced Poly(Phenylene Sulfide)

A sample of poly(phenylene sulfide) was synthesized in the presence of fluorinated single-walled carbon nanotubes (F-SWNT). The sample was prepared utilizing the procedure of Example 1 with the differences between the present example and Example 1 noted below.
1) The dehydration line was opened at 150° C. and the dehydration performed over a period of 65 minutes to collect 35 mL of liquid. Gas chromatography of the collected liquid indicated that the collected liquid contained 72.3 wt. % water and 27.7 wt. % N-methyl-2-pyrrolidone.
2) The dehydrated reactor content were cooled to 55° C. at which point 0.05 grams of fluorinated single-walled nanotubes having 15 wt. % fluorine were poured into the reactor (along with a rinse of 0.25 moles of N-methyl-2-pyrrolidone). A 50 psig nitrogen pressure was applied to the reactor after the fluorinated single-walled nanotubes were added to the reactor.
3) The contents of the para-dichlorobenzene/N-methyl-2-pyrrolidone charge vessel and the charge vessel rinse were added when the reactor temperature was approximately 55° C. A 140 psig nitrogen pressure was left on the reactor after the charging was complete.
4) A grey material with a solid ring on top was observed when the cooled reactor was opened. Gas chromatographic analysis of the recovered isopropyl alcohol extract indicated a 0.94 wt. % excess of para-dichlorobenzene.
5) The reinforced poly(phenylene sulfide) weighed 66.9 grams and had an Extrusion Rate (ER) of 22.4 (1.84 g/49.2 sec.) Assuming no loss of fluorinated single-walled nanotubes, the reinforced poly(phenylene sulfide) contained 0.075 wt. % single-walled nanotubes.
6) Acid washing of a 10 gram sample of the reinforced poly(phenylene sulfide) provided 8.8 grams of acid-washed reinforced poly(phenylene sulfide).

A film of the non-acid-washed poly(phenylene sulfide) was molded and a sample of the film were subjected to differential scanning calorimetry. Glass transition temperatures (T_{g}), crystallization temperatures from the glassy state (T_{cc}), melt temperatures (Tₘ), and melt crystallization temperatures (T_{mc}) for the sample is provided in Table 1.

### Example 3

### Non-Reinforced Poly(Phenylene Sulfide)

A sample of poly(phenylene sulfide) was synthesized in the absence of a reinforcing agent. To a 1-liter titanium reactor was added 0.666 moles of NaSH (62.50 grams), 0.680 moles of NaOH (27.61 grams), and 1.665 moles of N-methyl-2-pyrrolidone (165.05 grams). The reactor was closed and the reactor stirrer operated at 175 revolutions per minute. The reactor was purged of air by charging the reactor with nitrogen to 50 psig and then depressurizing the reactor five times and then charging the reactor with nitrogen to 200 psig and the depressurizing five times. Water was then removed (also referred to as dehydration) from the reactor by heating the reactor to approximately 130° C. The dehydration line was then opened, a nitrogen flow rate of 32 cc/minute initiated into the reactor, and the reactor heated to approximately 200° C. over a period of 90 minutes. During this time 25 mL of liquid was collected. Gas chromatography of the collected liquid indicated that the collected liquid contained 94.2 wt. % water and 5.8 weight % N-methyl-2-pyrrolidone.

To a 0.3 liter charging vessel was added 0.666 moles of para-dichlorobenzene (98.0 grams) and 0.5 moles of N-methyl-2-pyrrolidone (50 grams). The charging vessel was then purged with nitrogen, closed, and placed in a heated bath (at approximately 100° C.) until it was to be charged to the reactor.

Upon completion of the dehydration, the dehydration line was closed and the nitrogen flow was discontinued. The contents of the charging vessel were then pressured (nitrogen pressure) into the reactor. The charging vessel was rinsed with 0.5 moles of N-methyl-2-pyrrolidone (49.56 grams) and the rinse pressured (nitrogen pressure) into the reactor. The reactor was then pressured to 120 psig, the reactor temperature was increased to 250° C., and the reactor temperature maintained at 250° C. for approximately four hours.

The reactor was then cooled to room temperature overnight. The reactor was then opened to reveal a dry-cake material having a slight yellow color. The entire contents of the reactor was recovered from the reactor, washed with isopropyl alcohol, and filtered. The isopropyl alcohol extract was analyzed by gas chromatography. The gas chromatograph analysis of the recovered isopropyl alcohol extract indicated a 1.15 wt. % excess of para-dichlorobenzene. The recovered poly(phenylene sulfide) was washed with hot (90° C.) distilled water and filtered five times. The washed poly(phenylene sulfide) was then dried overnight in a vacuum oven operated at 100° C. at 12 inches of mercury (absolute). The poly(phenylene sulfide) weighed 67.07 grams and had an Extrusion Rate (ER) of 18.6 (2.03 g/65.27 sec.)

A sample of the poly(phenylene sulfide), 10 grams, was placed in a contained and covered with methanol and allowed to sit for 30 minutes. The contents of the filter was then filtered and the reinforced poly(phenylene sulfide) rinsed with 5 L of distilled water. The recovered reinforced poly(phenylene sulfide), 500 mL of distilled water, and 5 grams of glacial acetic acid were placed in a 1 liter titanium reactor. The reactor was closed, purged 5 times with 50 psig of nitrogen, and then purged 5 times with 200 psig of nitrogen. The reactor was then left with a 20 psig nitrogen atmosphere. Stirring was initiated at approximately 125 revolutions per minute, the reactor heated to 235° C., and the mixture maintained at 235° C. for 30 minutes. The reactor was then allowed to cool to room temperature and allowed to sit overnight.

The reactor was then opened and the entire contents of the reactor were recovered. The reactor contents were then filtered. The recovered acid-washed poly(phenylene sulfide) was washed with hot (90° C.) distilled water and filtered five times. The acid-washed poly(phenylene sulfide) was then dried overnight in a vacuum oven operated at 100° C. at 12 inches of mercury (absolute). The recovered acid-washed poly(phenylene sulfide) weighed 9.3 grams.

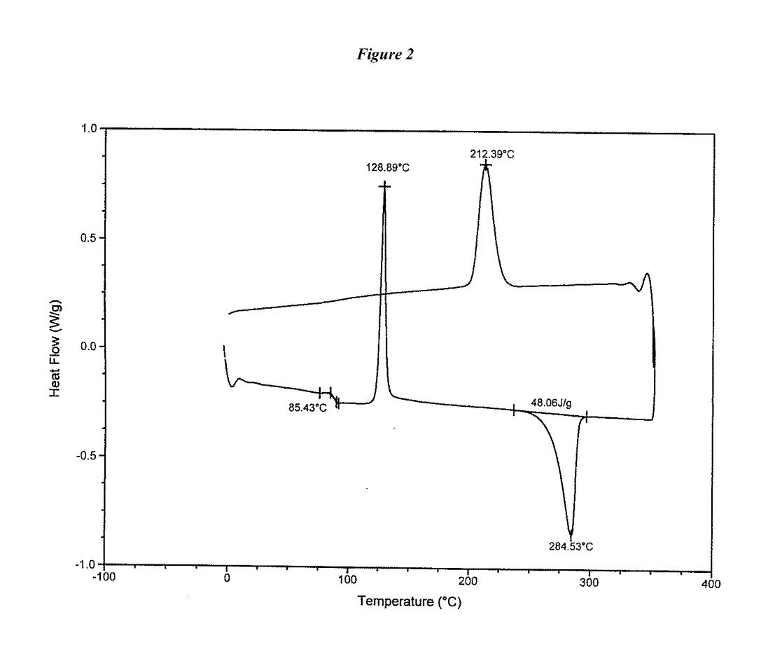

Films of the non-acid-washed poly(phenylene sulfide) and the acid-washed reinforced poly(phenylene sulfide) were molded and samples of the film were subjected to differential scanning calorimetry. Glass transition temperatures (T_{g}), crystallization temperatures from the glassy state (T_{cc}), melt temperatures (Tₘ), and melt crystallization temperatures (T_{mc}) for the two poly(phenylene sulfide) samples are provided in Table 1. FIG. 2 provides the DSC of the non-acid-washed poly(phenylene sulfide).

TABLE 1
Results of DSC Analyses

| | Nano- | Wt. % | | | | | |
|---|---|---|---|---|---|---|---|
| Exam- | tube | Nano- | Acid | T_{g} | T_{cc} | T_{mc} | Tₘ |
| ple # | Type | tubes | Washed | (° C.) | (° C.) | (° C.) | (° C.) |
| 1 | F- | 0.743 | No | 83.88 | 119.41 | 244.78 | 284.99 |
| | SWNT | | | | | | |
| 2 | F- | 0.075 | No | 85.24 | 126.13 | 236.79 | 284.6 |
| | SWNT | | | | | | |
| 3 | None | — | No | 85.43 | 128.89 | 212.39 | 284.53 |
| 1 | F- | 0.743 | Yes | 84.07 | 116.91 | 247.70 | 285.01 |
| | SWNT | | | | | | |
| 3 | none | — | Yes | 85.21 | 123.54 | 237.32 | 283.87 |

TABLE 2
Comparison of DSC Parameters of Reinforced Poly(Phenylene Sulfide)s
to Non-Reinforced Poly(Phenylene Sulfide) of Example 3.

| | | | | | | | | | |
|---|---|---|---|---|---|---|---|---|---|
| | ΔT_{cc} | | ΔT_{mc} | | CW | ΔCW | | | |
| Exam. | (° C.) | % ΔT_{cc} | (° C.) | ΔT_{mc} | (° C.) | (° C.) | % ΔCW | ΔCWR | % ΔCWR |

Non-Acid-Washed

| | | | | | | | | | |
|---|---|---|---|---|---|---|---|---|---|
| 1 | 9.48 | 7.36% | 32.39 | 15.25% | 125.37 | 41.87 | 50.14% | 0.62 | 48.69% |
| 2 | 2.76 | 2.14% | 24.40 | 11.49% | 110.66 | 27.16 | 32.53% | 0.56 | 32.46% |

Acid-Washed

| | | | | | | | | | |
|---|---|---|---|---|---|---|---|---|---|
| 1 | 6.63 | 5.37% | 10.38 | 4.37% | 130.79 | 17.01 | 14.95% | 0.65 | 13.61% |

The data in Table 1 and Table 2 along with FIG. 1 and FIG. 2 shows that the inclusion of fluorinated single-walled carbon nanotubes in the synthesis of poly(phenylene sulfide) decreases the crystallization temperature from the glassy state (T_{cc}) and increases the melt crystallization temperatures (T_{mc}) when compared to the crystallization temperature from the glassy state (T_{cc}) and the melt crystallization temperature (T_{mc}) of a similarly prepared poly(phenylene sulfide) produced without fluorinated single-walled carbon nanotubes. The decrease in the crystallization temperature from the glassy state (T_{cc}) and the increase the melt crystallization temperatures (T_{mc}) result in an increase in the crystallization window and the crystallization window ratio for the poly(phenylene sulfide)s produced in the presence of fluorinated single-walled carbon nanotubes as compared to similarly prepared poly(phenylene sulfide) produced without fluorinated single-walled carbon nanotubes.

### Example 4

### Single-Walled Carbon Nanotube Reinforced Poly(Phenylene Sulfide)

A sample of poly(phenylene sulfide) was synthesized in the presence of non-fluorinated single-walled carbon nanotubes (SWNT). The sample was prepared utilizing the procedure of Example 1 with the differences between the present example and Example 1 noted below.
1) The dehydration line was opened at 142° C. and the dehydration performed over a period of 75 minutes to collect 24 mL of liquid. Gas chromatography of the collected liquid indicated that the collected liquid contained 86.8 wt. % water and 13.2 wt. % N-methyl-2-pyrrolidone.
2) After the dehydration line was closed, the reactor was charged with 100 psig of nitrogen. The dehydrated reactor contents were cooled to 77° C. at which point 0.5 grams of non-fluorinated single-walled nanotubes were poured into the reactor. There was no N-methyl-2-pyrrolidone rinse. After the reactor was closed, a small nitrogen purge was performed.
3) The contents of the para-dichlorobenzene/N-methyl-2-pyrrolidone charge vessel and the charge vessel rinse (25 g N-methyl-2-pyrrolidone) were added when the reactor temperature was approximately 85° C. A 120 psig nitrogen pressure was left on the reactor after the charging was complete.
4) A medium grey semi-dry material was observed when the cooled reactor was opened. Gas chromatographic analysis of the recovered isopropyl alcohol extract indicated a 0.61 wt. % excess of para-dichlorobenzene.
5) The reinforced poly(phenylene sulfide) weighed 67.1 grams and had an Extrusion Rate (ER) of 15 (1.92 g/78.29 sec.) Assuming no loss of fluorinated single-walled nanotubes, the reinforced poly(phenylene sulfide) contained 0.745 wt. % single-walled nanotubes.
6) No acid-washing was performed on the reinforced poly(phenylene sulfide) sample.
7) No DSC was performed upon a film of the reinforced poly(phenylene sulfide).

### Example 5

### Single-Walled Carbon nanotube Reinforced Poly(Phenylene Sulfide)

A sample of poly(phenylene sulfide) was synthesized in the presence of non-fluorinated single-walled carbon nanotubes (SWNT). The sample was prepared utilizing the procedure of Example 1 with the differences between the present example and Example 1 noted below.
1) The dehydration line was opened at 140° C. and the dehydration performed over a period of 55 minutes to collect 30 mL of liquid. Gas chromatography of the collected liquid indicated that the collected liquid contained 73.0 wt. % water and 27.0 wt. % N-methyl-2-pyrrolidone.
2) After the dehydration line was closed, the reactor was charged with 100 psig of nitrogen. The dehydrated reactor contents were cooled to 80° C. at which point 0.5 grams of non-fluorinated single-walled nanotubes were poured into the reactor. There was no N-methyl-2-pyrrolidone rinse. After the reactor was closed, a small nitrogen purge was performed.
3) The contents of the para-dichlorobenzene/N-methyl-2-pyrrolidone charge vessel and the charge vessel rinse (25 g N-methyl-2-pyrrolidone) were added when the reactor temperature was approximately 82° C. A 110 psig nitrogen pressure was left on the reactor after the charging was complete.
4) A medium grey semi-dry material was observed when the cooled reactor was opened. Gas chromatographic analysis of the recovered isopropyl alcohol extract indicated a 0.61 wt. % excess of para-dichlorobenzene.
5) The reinforced poly(phenylene sulfide) weighed 68.6 grams and had an Extrusion Rate (ER) of 10 (1.83 g/113.57 sec.) Assuming no loss of fluorinated single-walled nanotubes, the reinforced poly(phenylene sulfide) contained 0.729 wt. % single-walled nanotubes.

In addition to acid washing a portion of the reinforced poly(phenylene sulfide), a second portion of the reinforced poly(phenylene sulfide) was washed with calcium acetate. The calcium acetate wash procedure was the same as the acid wash procedure with the exception that the 5 grams of glacial acetic acid was replaced with 5 grams of calcium acetate.

No DSCs were performed upon a film of the reinforced poly(phenylene sulfide), a film of the acid-washed reinforced poly(phenylene sulfide), or a film of the calcium-washed reinforced poly(phenylene sulfide).

### Example 6

### Non-Reinforced Poly(Phenylene Sulfide)

A sample of poly(phenylene sulfide) was synthesized in the absence of a reinforcing agent. The sample was prepared utilizing the procedure of Example 3 with the differences between the present example and Example 3 noted below.
1) The dehydration line was opened at 143° C. and the dehydration performed over a period of 33 minutes to collect 37 mL of liquid. Gas chromatography of the collected liquid indicated that the collected liquid contained 56.2 wt. % water and 44.8 wt. % N-methyl-2-pyrrolidone.
2) The contents of the para-dichlorobenzene/N-methyl-2-pyrrolidone charge vessel and the charge vessel rinse were added when the reactor temperature was 197° C. A 120 psig nitrogen pressure was left on the reactor after the charging was complete. The reaction was performed at approximately 246° C. for approximately 4 hours.
3) A whitish semi-dry cake material with a hint of green was observed when the cooled reactor was opened. Gas chromatographic analysis of the recovered isopropyl alcohol extract indicated a 0.57 wt. % excess of para-dichlorobenzene.
4) The poly(phenylene sulfide) was dried overnight in a vacuum oven operated at 100° C. at 12 inches of mercury (absolute). The poly(phenylene sulfide) weighed 68.0 grams and had an Extrusion Rate (ER) of 12.6 (1.93 g/91.88 sec.)

In addition to acid washing a portion of the poly(phenylene sulfide), a second portion of the poly(phenylene sulfide) was washed with calcium acetate. The calcium wash procedure was the same as the acid wash procedure with the exception that the 5 grams of glacial acetic acid was replaced with 5 grams of calcium acetate.

No DSCs were performed upon a film of the poly(phenylene sulfide), a film of the acid-washed poly(phenylene sulfide), or a film of the calcium-washed poly(phenylene sulfide).

### Example 7

### Cure Study of the Poly(Phenylene Sulfide) of Examples 4, 5, and 6

Samples of the single-walled carbon nanotube reinforced poly(phenylene sulfide) produced in Example 4, the single-walled carbon nanotube reinforced poly(phenylene sulfide) produced in Example 5, and the non-reinforced poly(phenylene sulfide) produced in Example 6 were cured in air at 248° C. for one and two hour and the analyzed for flow rate. The results of these analyses are provide in Table 3.

TABLE 3
Curing Poly(Phenylene Sulfide) Compositions

| Flow Rate | Example 4 | Example 5 | Example 6 |
|---|---|---|---|
| 1 Hour Cure | 61 | 96 | 87 |
| 2 Hour Cure | 21 | 37 | 40 |

These results show that the flow rate of carbon nanotube reinforced poly(phenylene sulfide) compositions can be the same or less than the flow rate of a similar poly(phenylene sulfide) composition devoid of carbon nanotube.

### Example 8

### Dispersion of Single-Walled Carbon Nanotubes in Poly(Phenylene Sulfide) Oligomers

A raw poly(phenylene sulfide) oligomer solution was obtained from a poly(phenylene sulfide) produced using the quench termination process. The raw poly(phenylene sulfide) oligomer solution was placed in a container and the solids allowed to settle. Once the solids had settled, a solids free poly(phenylene sulfide) oligomer solution was then isolated by decantation.

To an appropriately sized bottle was added 3.6585 grams of solid free poly(phenylene sulfide) oligomer solution and 0.0257 grams of single-walled carbon nanotubes. Into the bottle was inserted a sonic probe (model CV33) attached to a Cole-Parmer Ultrasonic Processor (Model CP750—750 watts and 20 kHz). The poly(phenylene sulfide) oligomer solution/single-walled carbon nanotube mixture was then sonicated at 20% amplitude with a pulse profile of 30 seconds on/10 seconds off for a total of 3 minutes to produce an extremely thick dispersion. To the poly(phenylene sulfide) oligomer solution/single-walled carbon nanotube dispersion was added 10.5314 grams of N-methyl-2-pyrrolidone. The poly(phenylene sulfide) oligomer solution/single-walled carbon nanotube/N-methyl-2-pyrrolidone mixture was then sonicated at 20% amplitude with a pulse profile of 30 seconds on/10 seconds off for a total of 6 minutes to produce a poly(phenylene sulfide) oligomer solution/single-walled carbon nanotube/N-methyl-2-pyrrolidone dispersion having a viscosity about equivalent to used motor oil. The single-walled carbon nanotubes remained dispersed in the remain poly(phenylene sulfide) oligomer solution/single-walled carbon nanotube/N-methyl-2-pyrrolidonedispersion, with no signs of settling, for over 24 hours before any signs of settling were observed.

### Example 9

### Blending of Aqueous Single-Walled Carbon Nanotube Solutions with Wet Poly(Phenylene Sulfide)

Three single-walled carbon nanotube reinforced poly(phenylene sulfide) compositions were prepared. Generally, the reinforced poly(phenylene sulfide) compositions were prepared by mixing an aqueous dispersion of single-walled nanotubes to a water wet sample of poly(phenylene sulfide). Each of the three reinforced poly(phenylene sulfide) compositions utilized a portion of a water wet poly(phenylene sulfide) containing 89 wt. % poly(phenylene sulfide) and 11 wt. % water. When dried the poly(phenylene sulfide) utilized in the three reinforced poly(phenylene sulfide) compositions had a Melt Flow (MF) of 483 g/10 min.

### Single-Walled Carbon Nanotube Reinforced Poly(Phenylene Sulfide) Composition 1

To a vial was added 27.8 g of water and 0.43 g of Nanosperse AQ. The mixture was mixed and then 0.53 g of single-walled nanotubes was added to the vial. Into the vial was inserted a sonic probe (model CV33) attached to a Cole-Parmer Ultrasonic Processor (Model CP750—750 watts and 20 kHz) and the mixture was then sonicated at 20% amplitude with a pulse profile of 30 seconds on and 5 seconds off for 15 minutes. The sonication yielded a single-walled carbon nanotube dispersion that appeared well mixed with some apparent aggregates sticking to the side of the container.

The aqueous single-walled nano-tube dispersion was then added to a bag containing 250 grams of the water wet poly(phenylene sulfide). The bag was then closed and shaken to blend the mixture. The contents of the bag contents were removed from the bag and then dried in a forced air oven operating at a temperature between ranging from 80° C. to 90° C. This single-walled carbon nanotube reinforced poly(phenylene sulfide composition contained 0.24 wt. % single-walled nanotubes.

### Single-Walled Carbon Nanotube Reinforced Poly(Phenylene Sulfide) Composition 2

To a vial was added 27.8 g of water and 0.22 g of Nanosperse AQ. The mixture was mixed and then 0.53 g of single-walled nanotubes was added to the vial. Into the vial was inserted a sonic probe (model CV33) attached to a Cole-Parmer Ultrasonic Processor (Model CP750—750 watts and 20 kHz) and the mixture was then sonicated at 20% amplitude with a pulse profile of 30 seconds on and 5 seconds off for 15 minutes. The sonication yielded a single-walled carbon nanotube dispersion that appeared well mixed with some apparent aggregates sticking to the side of the container.

The aqueous single-walled nano-tube dispersion was then added to a bag containing 112 grams of the water wet poly(phenylene sulfide). The bag was then closed and shaken to blend the mixture. The contents of the bag contents were removed from the bag and then dried in a forced air oven operating a temperature between ranging from 80° C. to 90° C. This single-walled carbon nanotube reinforced poly(phenylene sulfide composition contained 0.53 wt. % single-walled nanotubes.

### Single-Walled Carbon Nanotube Reinforced Poly(Phenylene Sulfide) Composition 3

To a vial was added 27.8 g of water and 0.22 g of Nanosperse AQ. The mixture was mixed and then 0.53 g of single-walled nanotubes was added to the vial. Into the vial was inserted a sonic probe (model CV33) attached to a Cole-Parmer Ultrasonic Processor (Model CP750—750 watts and 20 kHz) and the mixture was then sonicated at 20% amplitude with a pulse profile of 30 seconds on and 5 seconds off for 15 minutes. The sonication yielded a single-walled carbon nanotube dispersion that appeared well mixed with some apparent aggregates sticking to the side of the container.

In order to prevent water from overwhelming the poly(phenylene sulfide) and causing the poly(phenylene sulfide) to float in the water. The single-walled carbon nanotube dispersion added was divided into thirds and added to the water wet poly(phenylene sulfide). The first third of aqueous single-walled nano-tube dispersion was added to a bag containing 56 grams of the water wet poly(phenylene sulfide). The bag was then closed and shaken to blend the mixture. Excess water was removed from the mixture by subjecting the mixture to a vacuum filtration. The second third of the aqueous single-walled nano-tube dispersion was then added to a partially dried bag containing the first third of the single-walled nano-tubes. The bag was then closed and shaken to blend the mixture. Excess water was removed from the mixture by subjecting the mixture to a vacuum filtration. The final third of the aqueous single-walled nano-tube dispersion was then added to a second partially dried bag containing the first two thirds of the single-walled nano-tubes. The bag was then closed and shaken to blend the mixture. The contents of the bag contents were removed from the bag and then dried in a forced air oven operating at temperature between ranging from 80° C. to 90° C. This single-walled carbon nanotube reinforced poly(phenylene sulfide) composition contained 1.05 wt. % single-walled nanotubes.

### Melt Processing

Each of the single-walled carbon nanotube reinforced poly(phenylene sulfide) compositions were subjected to three different types of melt processing. These types of melt processing are designated Melt Process A, Melt Process B and Melt Process C. The melt processed single-walled carbon nanotube reinforced poly(phenylene sulfide) compositions are designated using the composition number and the melt process designation. For example, single-walled carbon nanotube reinforced poly(phenylene sulfide) composition 1 processed using melt process B is designated as Melt Processed Sample 1B

### Melt Process A

Melt Process A utilized a Dake 944250 die press to prepare a thin film of the single-walled carbon nanotube reinforced poly(phenylene sulfide) compositions. The thin films of the single-walled carbon nanotube reinforced poly(phenylene sulfide) composition were prepared following process:
1) Charge 6 to 7 grams of the single-walled carbon nanotube reinforced poly(phenylene sulfide) composition to a 5¼″×6¼″ 10 mil die;
2) Press the die to a pressure of 15,000 psi at a temperature of 555° F.
3) While maintaining a temperature of 555° F., relieve the pressure and hold for approximately 3 minutes without pressure;
4) While maintaining a temperature of 555° F., increase the pressure to 5000 psi and hold for 3 to 4 minutes and then increase the pressure to 15,000 psi for 1 minute;
5) While maintaining a temperature of 555° F., cycle the pressure from 150,000 psi to ambient to 15,000 psi to remove any bubbles; and
6) Transfer the die containing the secon die press and allow the plate to slowly cool to room temperature at a pressure of approximately 2000 psi.

### Melt Process B

Melt Process B utilized a melt index machine to prepare the melt processed single-walled carbon nanotube reinforced poly(phenylene sulfide) compositions. The single-walled carbon nanotube reinforced poly(phenylene sulfide) composition were prepared with a TINIUIS-OLSEN MP 993a Extrusion Plastometer using the following process:
1) Heat an 8 gram sample of the single-walled carbon nanotube reinforced poly(phenylene sulfide) composition to 315° C. and hold the single-walled carbon nanotube reinforced poly(phenylene sulfide) composition at 315° C. for 5 minutes; and
2) Extruded the heated single-walled carbon nanotube reinforced poly(phenylene sulfide) composition through the barrel of the plastometer using an 1168 gram weight.

### Melt Process C

Melt Process C utilized a DACA mini twin screw extruder to prepare melt process single-walled carbon nanotube reinforced poly(phenylene sulfide) compositions into an extrudate. The utilized DACA twin screw extruder had a bypass that recycles the extrudate. This apparatus allowed control over the residence time unlike a standard extruder where the residence time is a function of the length of the screw. The extrudate of the single-walled carbon nanotube reinforced poly(phenylene sulfide) composition were prepared with the mini twin screw extruder using the following process:
1) Charge the DACA mini twin screw extruder with 4 to 5 grams of the single-walled carbon nanotube reinforced poly(phenylene sulfide) composition;
2) Adjust the setting of the DACA mini twin screw extruder to operate 100 revolutions per minutes and 300° C. using a 5 minute recycle time before extrusion and a nitrogen purge during the melt/blend stage; and
3) Operate the DACA mini twin screw extruder to prepare the single-walled carbon nanotube reinforced poly(phenylene sulfide) composition extrudate.

### Analysis of Melt Processed Single-Walled Carbon Nanotube Reinforced Poly(Phenylene Sulfide) Compositions

Each of the melt processed single-walled carbon nanotube reinforced poly(phenylene sulfide) compositions were analyzed for their crystallization behavior using differential scanning calorimetry conductivity properties (using a surface Resistivity Meter), and optical properties (using an optical microscope). Melt processed single-walled carbon nanotube reinforced poly(phenylene sulfide) compositions prepared by Melt Process B and Melt Process C were converted to thin films by subjecting a sample to the melt processed single-walled carbon nanotube reinforced poly(phenylene sulfide) compositions to the die press procedure of Melt Process A. Melt processed single-walled carbon nanotube reinforced poly(phenylene sulfide) compositions prepared by Melt Process A were utilized in the form they were prepared.

### Differential Scanning Calorimetry Analysis

DSC samples of melt processed single-walled carbon nanotube reinforced poly(phenylene sulfide) compositions were obtained by using a hole punch to cut a 8-9 mg sample from the films. The differential scanning calorimetry analysis was performed by placing the 8-9 mg sample placed in a closed aluminum pan of a TA Instruments Q 100 differential scanning calorimeter an subjecting the sample to two heating/cooling cycles. The first heating/cooling cycle was conducted by equilibrating the sample at 40° C. for 10 minutes, heating the sample at heating rate of 10° C./min from 40° C. to 350° C., equilibrating the sample under isothermal conditions at 350° C. for 5 minutes, and then cooling the sample at rate of 10° C./min from 350° C. to 40° C. The sample was then equilibrated under isothermal conditions at 40° C. for 10 minutes before initiating the second heating/cooling cycle using the same conditions at the first heating/cooling cycle. Table 2 provides the first pass and send pass melt crystallization temperatures (T_{mc}) for each of the melt processed single-walled carbon nanotube reinforced poly(phenylene sulfide) compositions.

TABLE 4
Melt Crystallization Temperature (T_{mc}) from the DSC Analyses
of the Melt Processed Single-Walled Carbon Nanotube Reinforced
Poly(phenylene Sulfide) Composition of Example 12.

| Wt. % | | | |
|---|---|---|---|
| Single-Walled | Melt | T_{mc} 1^{st} Pass | T_{mc} 2^{nd} Pass |
| Nanotubes | Process | (° C.) | (° C.) |
| 0.2 | A | 236.48 | 248.98 |
| 0.2 | B | 242.99 | 250.22 |
| 0.2 | C | 241.85 | 245.82 |
| 0.5 | A | 232.31 | 234.22 |
| 0.5 | B | 235.10 | 245.82 |
| 0.5 | C | 239.80 | 244.76 |
| 1.0 | A | 233.01 | 237.91 |
| 1.0 | B | 237.19 | 242.65 |
| 1.0 | C | 245.02 | 249.51 |

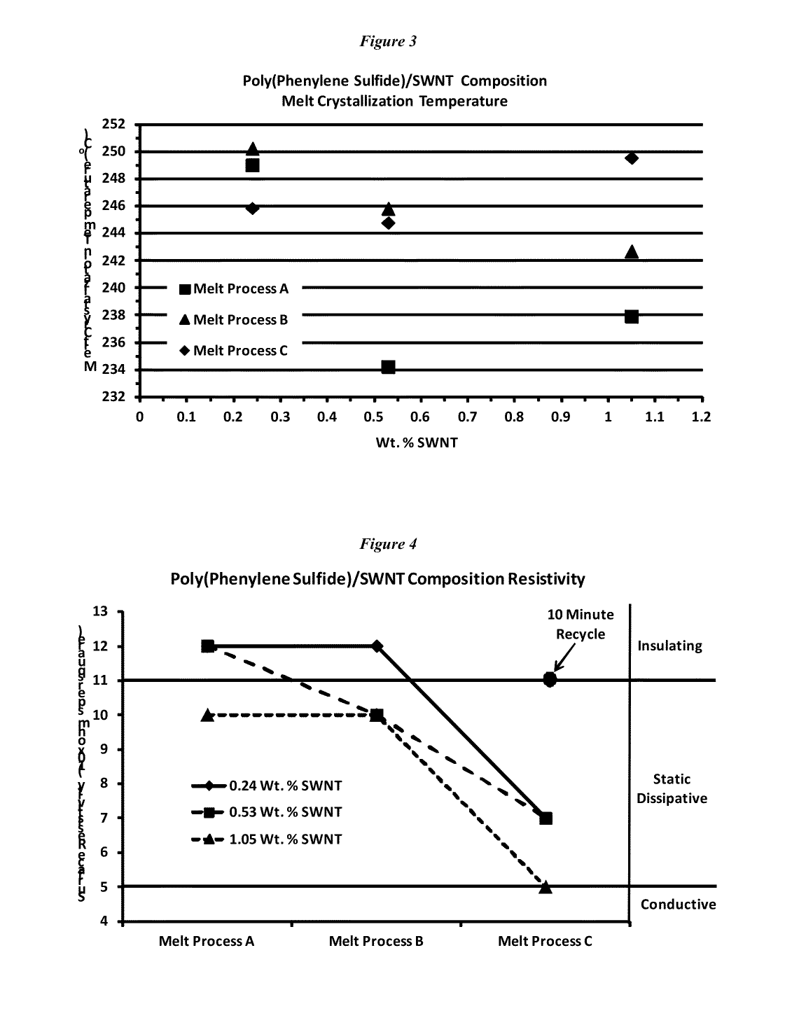

The differential scanning calorimetry results suggest that each of the melt processing methods provide a different heat history to the melt processed single-walled carbon nanotube reinforced poly(phenylene sulfide) compositions. It was assumed that the melt crystallization temperature of the second heating/cooling cycle represented the equilibrium melt crystallization temperature. FIG. 3 provides a graphical visualization of the equilibrium melt crystallization temperature for the melt processed single-walled carbon nanotube reinforced poly(phenylene sulfide) compositions.

The limited equilibrium melt crystallization temperature (T_{mc}) for the melt processed single-walled carbon nanotube reinforced poly(phenylene sulfide) compositions made reaching conclusions regarding the impact that the single-walled carbon nanotubes have on the crystallization behavior of the melt processed single-walled carbon nanotube reinforced poly(phenylene sulfide) compositions. However, aside from the outliers (which can be caused by inconsistencies in the populations of aggregates), it appears that increasing concentration and dispersion of single-walled carbon nanotubes in the melt processed single-walled carbon nanotube reinforced poly(phenylene sulfide) compositions results in faster crystallization kinetics. The effect on the T_{g} was not observed and no T_{cc} was observed because the thin films were not quenched after they were pressed.

### Conductivity Analysis

Surface resistivity measurements were taken on the films using a Monroe Electronics 26A Surface Resistivity Meter having a resistivity scale from 1×10⁴ to 1×10¹⁴ ohms and ohms per square and a listed accuracy of ±½ decade. Usually, materials having a surface resistivity less than 1×10⁵ are considered conductive and materials having a surface resistivity greater than 1×10¹² are considered insulative. Materials having a surface resistivity greater than 1×10⁵ and less than 1×10¹² are considered dissipative (sometime referred to as static dissipative). FIG. 4 provides the visual depiction of the surface resistivity of the melt processed single-walled carbon nanotube reinforced poly(phenylene sulfide) compositions.

The surface resistivity measurements on the melt processed single-walled carbon nanotube reinforced poly(phenylene sulfide) compositions indicate the melt processed single-walled carbon nanotube reinforced poly(phenylene sulfide) compositions produced using Melt Processing Method C (extrusion using a mini extruder) provided the lowest surface resistivity (or highest surface conductivity). These result coupled with the optical analysis of the melt processed single-walled carbon nanotube reinforced poly(phenylene sulfide) compositions appear to show that surface resistivity decreases (or surface conductivity increases) with increasing dispersion of the single-walled nanotubes in the single-walled nanotubes reinforced poly(phenylene sulfide) composition.

To determine whether too much shear could cause degradation in the structure of the melt processed single-walled carbon nanotube reinforced poly(phenylene sulfide) composition a sample of the melt processed single-walled carbon nanotube reinforced poly(phenylene sulfide) composition having 0.2 wt % single-walled nanotubes was processed using the Melt Process C where the recycle was set for 10 minutes rather than 5 minutes for the other single-walled carbon nanotube reinforced poly(phenylene sulfide) composition. The resulting thin film had a surface resistivity of 10¹⁰ ohms/square. The higher resistivity of this film as compared to the surface resistivity of 10⁷ ohms/square for the same composition prepared using a recycle time of 5 minutes indicates appears to indicate that too much shear can cause degradation in the structure of the melt processed single-walled carbon nanotube reinforced poly(phenylene sulfide) composition.

### Optical Analysis

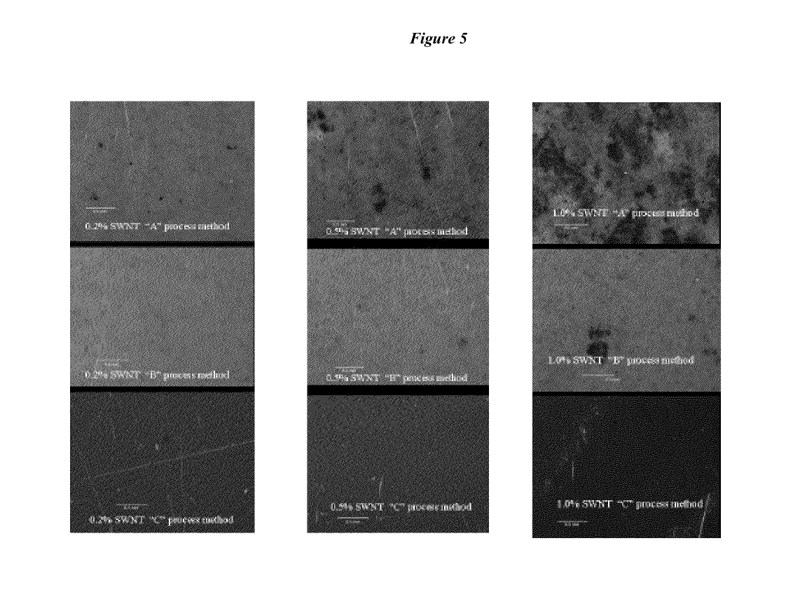

Optical analysis of the single-walled carbon nanotube reinforced poly(phenylene sulfide) composition films were carried out using an optical microscope operating at 64×. FIG. 5 provides the micrographs of the melt processed single-walled carbon nanotube reinforced poly(phenylene sulfide) composition films.

The micrographs of the single-walled carbon nanotube reinforced poly(phenylene sulfide) compositions produced using Melt Process A had an obvious “salt and pepper” look. The micrographs of the single-walled carbon nanotube reinforced poly(phenylene sulfide) compositions produced using Melt Process B had more uniform in appearance with an occasional large black speck. The micrographs of the single-walled carbon nanotube reinforced poly(phenylene sulfide) compositions produced using Melt Process C had very few observable specks. Additionally, the micrographs of the single-walled carbon nanotube reinforced poly(phenylene sulfide) compositions produced using Melt Process C appeared to have phases with differing dispersion. The phases having differing dispersions manifested as a swirling effect of the films. Regardless of the Melt Process utilized, the darkness of the films increased and the amount of aggregates increased with increasing single-walled carbon nanotube content. Additionally, regardless of the Melt Process utilized the films of the single-walled carbon nanotube reinforced poly(phenylene sulfide) composition containing 1.05 wt. % single-walled nanotubes had a shiny surface and appeared to be laminated.

The optical analyses did not provide any evidence that the single-walled carbon nanotube bundles are broken down by the process used to produce the single-walled carbon nanotube reinforced poly(phenylene sulfide) compositions and the melt process utilized to produce the melt processed single-walled carbon nanotube reinforced poly(phenylene sulfide) compositions. Additionally, it appears as the single-walled nanotubes aggregates are broken down (become smaller) with increasing shear of the melt process utilized to produce the melt processed single-walled carbon nanotube reinforced poly(phenylene sulfide) compositions.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1. A process of preparing a reinforced poly(arylene sulfide) composition comprising:
a) contacting
i) a reinforcing agent composition comprising a graphene, a functionalized graphene, or a combination thereof,
ii) at least one halogenated aromatic compound having two halogens,
iii) a sulfur compound, and
iv) a first polar organic compound to form a poly(arylene sulfide) and
b) recovering the reinforced poly(arylene sulfide) composition.

2. The process of claim 1, wherein the poly(arylene sulfide) of the reinforced poly(arylene sulfide) composition comprises at least 70 mole % of recurring units having Formula I: 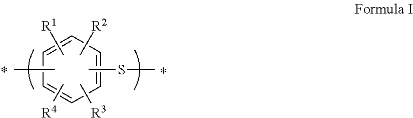
wherein each R¹, R², R³, and R⁴ can independently be hydrogen or any radical organyl group.

3. The process of claim 1, wherein the reinforced poly(arylene sulfide) composition is a reinforced poly(phenylene sulfide) composition and the poly(phenylene sulfide) of the poly(phenylene sulfide) composition comprises at least 70 mole % of recurring units having Formula II:

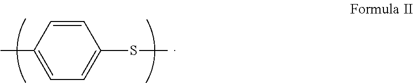

4. The process of claim 1, wherein the reinforcing agent composition comprises a fullerene, a functionalized fullerene, or any combination thereof.

5. The process of claim 1, wherein the reinforcing agent composition comprises a carbon nanotube a functionalized nanotube, or any combination thereof.

6. The process of claim 1, wherein the functionalized graphene comprises a halogen.

7. The process of claim 1, wherein the reinforced poly(arylene sulfide) composition is a reinforced poly(phenylene sulfide) composition, the reinforcing agent composition comprises carbon nanotubes, functionalized carbon nanotubes, or a combination thereof, the dihaloaromatic compound comprises a para-dihalobenzene, and the functionalized carbon nanotubes comprise a halogen.

8. The process of claim 7, wherein the reinforcing agent composition is prepared by contacting the graphene, the functionalized graphene, or a combination thereof with a liquid medium prior to contacting the reinforcing agent with the at least one at least one halogenated aromatic compound having two halogens, the sulfur compound, and the first polar organic compound.

9. The process of claim 8, wherein the reinforcing agent composition comprises carbon nanotubes, functionalized carbon nanotubes, or a combination thereof and wherein the liquid medium comprises poly(phenylene sulfide) oligomers.

10. The process of claim 1, wherein the recovered reinforced poly(arylene sulfide) composition is melt processed, and the melt processed reinforced poly(arylene sulfide) composition has a property selected from:
(1) a cold crystallization temperature lower than a cold crystallization temperature of an otherwise similar poly(arylene sulfide) composition lacking the reinforcing agent;
(2) a melt crystallization temperature higher than a melt crystallization temperature of an otherwise similar poly(arylene sulfide) composition lacking the reinforcing agent;
(3) a crystallization temperature window larger than a crystallization temperature window of an otherwise similar poly(arylene sulfide) composition lacking the reinforcing agent;
(4) a crystallization window ratio greater than a crystallization window ratio of an otherwise similar poly(arylene sulfide) composition lacking the reinforcing agent; and
(5) a surface electrical resistivity that is less than a surface electrical resistivity of an otherwise similar poly(arylene sulfide) composition lacking the reinforcing agent.

11. A process of producing reinforced poly(arylene sulfide) composition comprising:
a) contacting
i) a poly(arylene sulfide) composition comprising a poly(arylene sulfide) and wherein the poly(arylene sulfide) composition is essentially devoid of a liquid medium, and
ii) a reinforcing agent composition comprising a graphene and wherein the reinforcing agent composition is essentially devoid of a liquid medium, to form a mixture; and
b) melt processing the mixture.

12. The process of claim 11, wherein the poly(arylene sulfide) and the graphene are contacted at a poly(arylene sulfide) to graphene weight ratio ranging from 1000:1 to 1:1.

13. The process of claim 11, wherein the reinforced poly(arylene sulfide) composition has poly(arylene sulfide) to graphene weight ratio ranging from 1000:1 to 9:1, and wherein the reinforced poly(arylene sulfide) composition has a property selected from:
(1) a cold crystallization temperature lower than a cold crystallization temperature of an otherwise similar poly(arylene sulfide) composition lacking the reinforcing agent,
(2) a melt crystallization temperature higher than a melt crystallization temperature of an otherwise similar poly(arylene sulfide) composition lacking the reinforcing agent,
(3) a crystallization temperature window larger than a crystallization temperature window of an otherwise similar poly(arylene sulfide) composition lacking the reinforcing agent,
(4) a crystallization window ratio greater than a crystallization window ratio of an otherwise similar poly(arylene sulfide) composition lacking the reinforcing agent; and
(5) a surface electrical resistivity that is less than a surface electrical resistivity of an otherwise similar poly(arylene sulfide) composition lacking the reinforcing agent.

14. A process of forming a reinforced poly(arylene sulfide) composition comprising:
a) contacting
1) a mixture formed from a first mixture comprising
i) a first poly(arylene sulfide) composition comprising a poly(arylene sulfide) and wherein the first poly(arylene sulfide) composition is essentially devoid of a liquid medium, and
ii) a reinforcing agent composition comprising a graphene and wherein the reinforcing agent composition is essentially devoid of a liquid medium and;
2) a second poly(arylene sulfide) composition comprising a poly(arylene sulfide and wherein the second poly(arylene sulfide) composition is essentially devoid of a liquid medium to form a second mixture; and
b) melt processing the second mixture.

15. The process of claim 14, wherein weight ratio of the poly(arylene sulfide) of the first poly(arylene sulfide) composition to the poly(arylene sulfide) of the second polyarylene sulfide composition ranges from 1:1 to 1:50.

16. The process of claim 14, wherein one or more of the first mixture, the second mixture, the first poly(arylene sulfide) composition, or the second poly(arylene sulfide) composition further comprises one or more additives.

17. The process of claim 14, wherein the one or more of the first mixture, the second mixture, the first poly(arylene sulfide) composition, or the second poly(arylene sulfide) composition further comprises a fire retardant, a stabilizer, an ultraviolet absorber, a lubricant, a pigment, a filler, or any combination thereof.

18. The process of claim 14, wherein the one or more of the first mixture, the second mixture, the first poly(arylene sulfide) composition, or the second poly(arylene sulfide) composition further comprises a filler.

19. The process of claim 14, wherein the melt processed second mixture has poly(arylene sulfide) to graphene weight ratio ranging from 1000:1 to 9:1 and the reinforced poly(arylene sulfide) composition has a property selected from:
(1) a cold crystallization temperature lower than a cold crystallization temperature of an otherwise similar poly(arylene sulfide) composition lacking the reinforcing agent;
(2) a melt crystallization temperature higher than a melt crystallization temperature of an otherwise similar poly(arylene sulfide) composition lacking the reinforcing agent;
(3) a crystallization temperature window larger than a crystallization temperature window of an otherwise similar poly(arylene sulfide) composition lacking the reinforcing agent;
(4) a crystallization window ratio greater than a crystallization window ratio of an otherwise similar poly(arylene sulfide) composition lacking the reinforcing agent; and
(5) a surface electrical resistivity that is less than a surface electrical resistivity of an otherwise similar poly(arylene sulfide) composition lacking the reinforcing agent.

20. A process of producing a reinforced poly(arylene sulfide) composition comprising:
A) contacting a poly(arylene sulfide) composition comprising a poly(arylene sulfide) and a first liquid medium and a reinforcing agent composition comprising a graphene and a second liquid medium;
B) dispersing the reinforcing agent composition into the poly(arylene sulfide) composition to form a first mixture; and
C) removing the first liquid medium and the second liquid medium from the first mixture to form a second mixture comprising the poly(arylene sulfide) and the graphene.

21. The process of claim 20, further comprising melt processing the second mixture.

22. The process of claim 20, wherein the first liquid medium and the second liquid medium comprise water.

23. The process of claim 20, wherein the reinforcing agent composition is produced by i) contacting the graphene, the second liquid medium, and a dispersing agent, and ii) dispersing the graphene in the second liquid medium.

24. The process of claim 20, wherein the poly(arylene sulfide) composition is prepared by:
a) contacting at least one dihaloaromatic compound, a sulfur compound, and a polar organic compound to form a poly(arylene sulfide);
b) recovering the poly(arylene sulfide), and
c) washing the poly(arylene sulfide) with water to form a poly(arylene sulfide) composition consisting essentially of poly(arylene sulfide) and water; and
wherein the reinforcing agent composition is produced by
i) contacting the graphene, the second liquid medium, and a dispersing agent, and
ii) dispersing the reinforcing agent in the second liquid medium.

25. The process of claim 24, wherein the graphene is dispersed in the second liquid medium utilizing ultrasonication, mechanical stirring, or a combination thereof.

26. The process of claim 24, further comprising melt processing the second mixture,
wherein the melt processed second mixture has poly(arylene sulfide) to graphene weight ratio ranges from 1000:1 to 9:1 and
wherein the reinforced poly(arylene sulfide) composition has a property selected from
(1) a cold crystallization temperature lower than a cold crystallization temperature of an otherwise similar poly(arylene sulfide) composition lacking the reinforcing agent;
(2) a melt crystallization temperature higher than a melt crystallization temperature of an otherwise similar poly(arylene sulfide) composition lacking the reinforcing agent;
(3) a crystallization temperature window larger than a crystallization temperature window of an otherwise similar poly(arylene sulfide) composition lacking the reinforcing agent;
(4) a crystallization window ratio greater than a crystallization window ratio of an otherwise similar poly(arylene sulfide) composition lacking the reinforcing agent; and
(5) a surface electrical resistivity that is less than a surface electrical resistivity of an otherwise similar poly(arylene sulfide) composition lacking the reinforcing agent.
